(19) United States
(12) Patent Application Publication
(10) Pub. No.: US 2019/0100877 A1
(43) Pub. Date: Apr. 4, 2019

(54) SHEET MANUFACTURING APPARATUS

(71) Applicant: SEIKO EPSON CORPORATION, Tokyo (JP)

(72) Inventor: Yuki OGUCHI, Okaya-shi (JP)

(73) Assignee: SEIKO EPSON CORPORATION, Tokyo (JP)

(21) Appl. No.: 16/146,549

(22) Filed: Sep. 28, 2018

(30) Foreign Application Priority Data
Sep. 29, 2017 (JP) 2017-189890
Sep. 29, 2017 (JP) 2017-189891

(51) Int. Cl. D21F 7/00; B29C 43/00; B29C 43/24; B29C 43/58; D21H 15/10; D21B 1/08

(52) U.S. Cl. CPC D21F 7/00; B29C 43/003; B29C 43/245; B29K 2105/26; D21H 15/10; D21B 1/08; B29C 43/58

(57) ABSTRACT

A sheet manufacturing apparatus can easily adjust the stiffness of sheets made by the sheet manufacturing apparatus. The sheet manufacturing apparatus has a first material supply device that supplies a first material containing fiber; a second material supply device that supplies a second material containing fiber with an average fiber length shorter than the average fiber length of the first material; and a controller configured to control operation of the first material supply device and second material supply device. The controller has a first mode in which the first material is supplied from the first material supply device, and a second mode in which the second material is supplied from the second material supply device, and selects either the first mode or the second mode.

### BACKGROUND

### 1. Technical Field

The present invention relates to a sheet manufacturing apparatus.

### 2. Related Art

With increased concern about the environment, interest in both reducing consumption of paper and recycling paper has grown. See, for example, JP-A-2014-208925 and JP-A-2006-104622.

JP-A-2014-208925 describes a sheet manufacturing apparatus having a defibrator for defibrating recovered paper, a separator for separating unwanted foreign matter from the defibrated material defibrated by the defibrator, and a forming unit for laying the defibrated material from which foreign matter was removed and forming a sheet. The sheet manufacturing apparatus thereby enables reusing recovered paper as recycled paper.

A problem with recycled paper made from recovered paper is that because the fiber length of the pulp tends to be relatively short, paper strength (the stiffness of the paper) also tends to drop and paper dust is easily produced during the recycling process.

JP-A-2006-104622 therefore proposes preventing a drop in paper strength, that is, adjusting the paper strength, while suppressing the production of paper dust by applying an alkaline digestible biodegradable plastic to the surface of recycled paper containing recycled pulp.

However, if there is variation in the paper strength of the recovered paper that is loaded as the feedstock into the sheet manufacturing apparatus described in JP-A-2014-208925, variation also occurs in the defibration speed and accumulation (laying) rate, and, in turn, this may cause variation in the paper strength of the recycled paper.

A problem with JP-A-2006-104622 is that the process of disposing a layer of alkaline digestible biodegradable plastic to the surface of recycled paper is relatively complex.

Adjusting the paper strength of recycled paper is therefore difficult, and requires a complicated process.

### SUMMARY

An object of several embodiments of the invention is to provide a sheet manufacturing apparatus enabling easily adjusting the stiffness of the sheets manufactured by the sheet manufacturing apparatus.

The present invention is directed to solving at least part of the foregoing problem, and may be embodied as described below.

A sheet manufacturing apparatus according to an aspect of the invention has a first material supply device that supplies a first material containing fiber; a second material supply device that supplies a second material containing fiber with an average fiber length shorter than the average fiber length of the first material; and a controller configured to control operation of the first material supply device and second material supply device.

This aspect of the invention enables making sheets with the desired stiffness by the simple configuration of controlling operation of the first material supply device and second material supply device to set (select) using either or both the first material and second material. In other words, the stiffness of the sheets being made can be easily adjusted.

In a sheet manufacturing apparatus according to another aspect of the invention, the controller has a first mode in which the first material is supplied from the first material supply device, and a second mode in which the second material is supplied from the second material supply device, and selects either the first mode or the second mode.

This configuration enables selecting whether to make sheets with relatively high stiffness, or make sheets with relatively low stiffness.

In a sheet manufacturing apparatus according to another aspect of the invention, the controller has a third mode including a first state in which the first material is supplied from the first material supply device, and a second state in which the second material is supplied from the second material supply device, and supplies material from both the first material supply device and the second material supply device.

This configuration enables adjusting the supply volume (supply ratio) of first material and second material. As a result, this configuration also enables adjusting the stiffness of the manufactured sheets in steps.

Preferably in a sheet manufacturing apparatus according to another aspect of the invention, the controller determines the operating mode according to the stiffness of the manufactured sheets.

This configuration enables the sheets that are made to have the set stiffness.

Preferably in a sheet manufacturing apparatus according to another aspect of the invention, in the third mode, the controller repeatedly alternates between the first state and second state.

This configuration can make the stiffness uniform across the surface of the manufactured sheets.

Preferably in a sheet manufacturing apparatus according to another aspect of the invention, in the third mode, the controller can adjust a first supply volume of the first material in the first state, and a second supply volume of the second material in the second state.

This enables adjusting the supply volume (supply ratio) of the first material and second material in steps. As a result, this configuration also enables adjusting the stiffness of the manufactured sheets in steps.

Preferably in a sheet manufacturing apparatus according to another aspect of the invention, the controller determines the first supply volume and the second supply volume according to the stiffness of the manufactured sheets.

This configuration enables manufacturing sheets with the desired set stiffness.

Preferably in a sheet manufacturing apparatus according to another aspect of the invention, in the third mode, the controller can adjust the timing when the first material is supplied in the first state, and the timing when the second material is supplied in the second state, based on the average fiber length of the first material and the average fiber length of the second material.

This configuration can make the stiffness uniform across the surface of the manufactured sheets.

Preferably in a sheet manufacturing apparatus according to another aspect of the invention, the first material and second material are sheet materials; and the controller adjusts the first supply volume and second supply volume by adjusting the number of sheets supplied.

This configuration enables easily controlling adjustment of the stiffness of the manufactured sheets.

A sheet manufacturing apparatus according to another aspect of the invention preferably also has a defibrator configured to defibrate the sheet material.

This configuration enables making sheets from sheets as the feedstock.

A sheet manufacturing apparatus according to another aspect of the invention also has a space that allows deformation of the sheet material; a detector configured to detect deformation of the sheet material in the space; and an evaluator configured to determine the stiffness of the sheet material based on the detection result of the detector.

This configuration enables measuring the stiffness of the sheets (sheet material) produced by the sheet manufacturing apparatus, or measuring the stiffness of the feedstock (sheet material) supplied to the sheet manufacturing apparatus. Operation of the sheet manufacturing apparatus can therefore be adjusted based on the results of the measurements.

Preferably in a sheet manufacturing apparatus according to another aspect of the invention, the detector is an optical device configured to measure a length of deformation of the sheet material.

This configuration enables accurately measuring by a simple configuration the distance to the deformation.

Preferably in a sheet manufacturing apparatus according to another aspect of the invention, the detector detects deformation resulting from the sheet material sagging due to the weight of the sheet material.

This configuration prevents applying excessive external force to the sheet material to make the sheet material bend.

Preferably, a sheet manufacturing apparatus according to another aspect of the invention also has a reporting device configured to report the detection result of the detector.

As described further below, this configuration enables informing the operator that the stiffness of the manufactured sheet is outside the desired range.

Preferably, a sheet manufacturing apparatus according to another aspect of the invention also has a sorter configured to sort the sheet material according to the detection result of the detector.

This configuration enables sorting the sheet material according to the detection result from the detector.

Preferably, a sheet manufacturing apparatus according to another aspect of the invention also has a controller configured to adjust an operating condition of the sheet manufacturing apparatus based on the detection result of the detector.

This configuration enables making sheet materials with the desired stiffness.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 schematically illustrates the configuration of a first embodiment of a sheet manufacturing apparatus according to the invention.

FIG. 2 is a flow chart of processes executed by the sheet manufacturing apparatus shown in FIG. 1.

FIG. 3 is a block diagram of the sheet manufacturing apparatus shown in FIG. 1.

FIG. 4 is a timing chart of a first mode executed by the controller shown in FIG. 3.

FIG. 5 is a timing chart of a second mode executed by the controller shown in FIG. 3.

FIG. 6 is a timing chart of a third mode executed by the controller shown in FIG. 3.

FIG. 7 is a timing chart of a third mode executed by the controller shown in FIG. 3.

FIG. 8 is a timing chart of a third mode executed by the controller shown in FIG. 3.

FIG. 9 is a flow chart describing the control operation of the controller shown in FIG. 3.

FIG. 10 is a timing chart of a third mode executed by the controller of a sheet manufacturing apparatus according to the second embodiment of the invention.

FIG. 11 is a vertical section view schematically illustrating a second web.

FIG. 12 is a vertical section view schematically illustrating a second web.

FIG. 13 schematically illustrates the configuration of a third embodiment of a sheet manufacturing apparatus according to the invention.

FIG. 14 is a block diagram of the sheet manufacturing apparatus shown in FIG. 13.

FIG. 15 schematically illustrates a stiffness tester according to a third embodiment of the invention.

FIG. 16 illustrates an operating state of the stiffness tester shown in FIG. 15.

FIG. 17 illustrates an operating state of the stiffness tester shown in FIG. 15.

FIG. 18 illustrates an operating state of the stiffness tester shown in FIG. 15.

FIG. 19 is a flow chart of the control operation of the controller shown in FIG. 13.

FIG. 20 is a flow chart of the control operation of the controller of a sheet manufacturing apparatus according to a fourth embodiment of the invention.

FIG. 21 is a flow chart of the control operation of the controller of a sheet manufacturing apparatus according to a fifth embodiment of the invention.

FIG. 22 is a flow chart of the control operation of the sorter in the stiffness tester of a sheet manufacturing apparatus according to a sixth embodiment of the invention.

FIG. 23 is a flow chart of the control operation of the sorter in the stiffness tester of a sheet manufacturing apparatus according to a sixth embodiment of the invention.

FIG. 24 is a flow chart of the control operation of the controller of a sheet manufacturing apparatus according to a sixth embodiment of the invention.

FIG. 25 illustrates a stiffness tester of a sheet manufacturing apparatus according to a seventh embodiment of the invention.

FIG. 26 schematically illustrates the configuration of sheet manufacturing apparatus according to an eighth embodiment of the invention.

FIG. 27 is a flow chart of the control operation of the controller shown in FIG. 26.

FIG. 28 schematically illustrates the configuration of a sheet manufacturing apparatus according to the ninth embodiment of the invention.

FIG. 29 schematically illustrates the configuration of a sheet manufacturing apparatus according to the tenth embodiment of the invention.

### DESCRIPTION OF EMBODIMENTS

Preferred embodiment of the invention of a sheet manufacturing apparatus according to the invention are described below with reference to the accompanying figures.

Note that for convenience in the description below, the side at the top is referred to as up or above; the bottom is referred to as down or below; the left side is referred to as the left or the upstream side; and the right side is referred to as the right or the downstream side.

### Embodiment 1

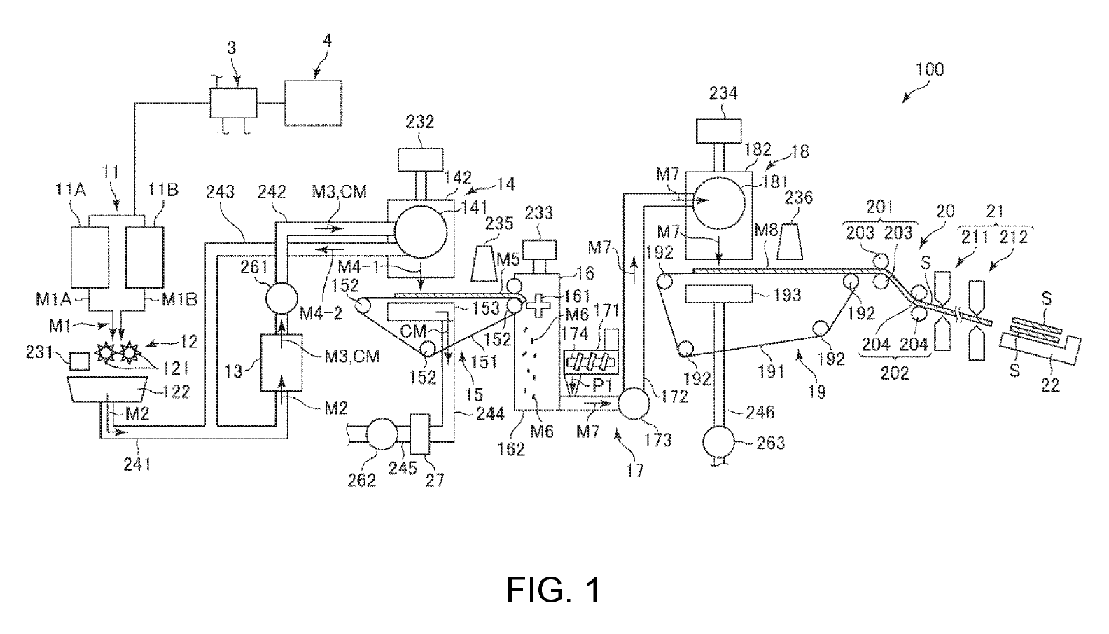

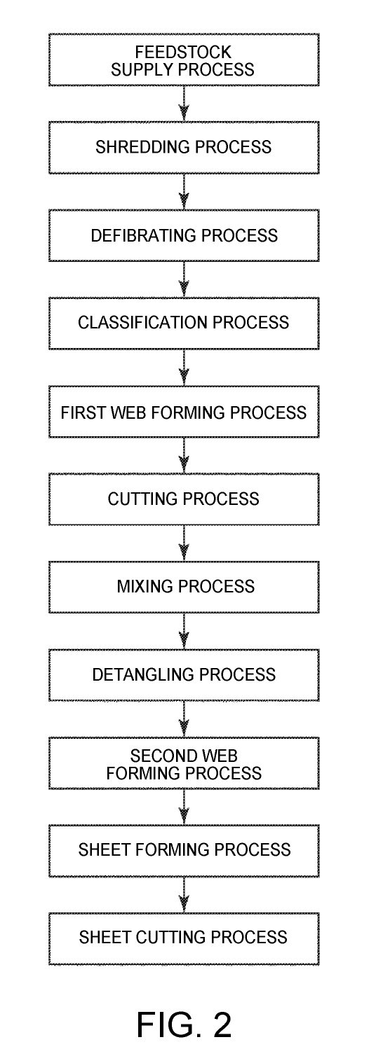

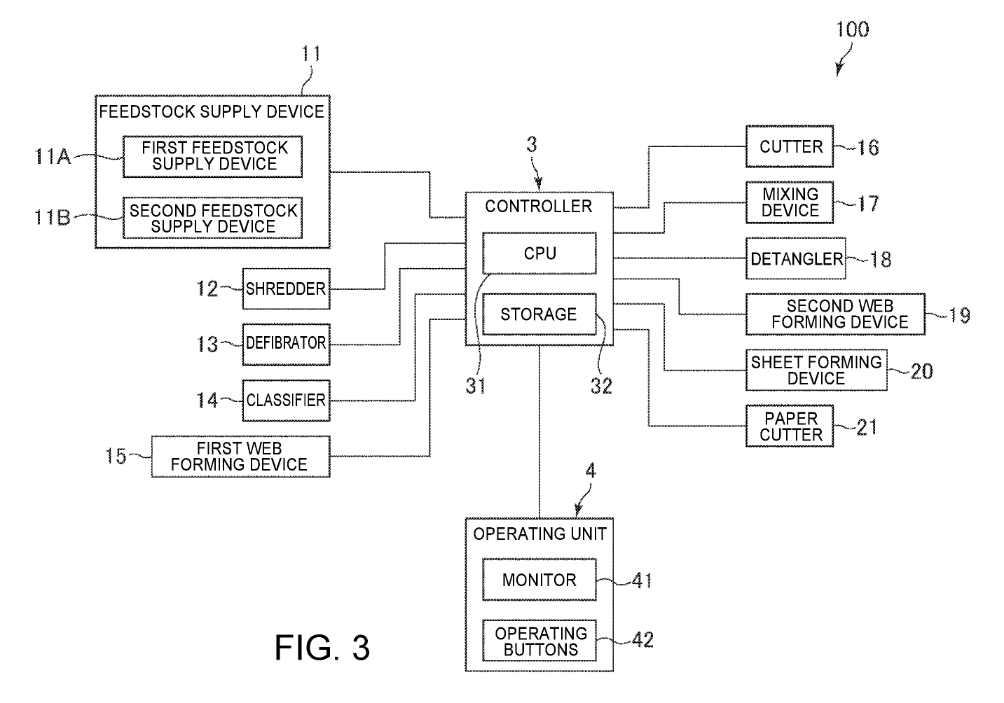

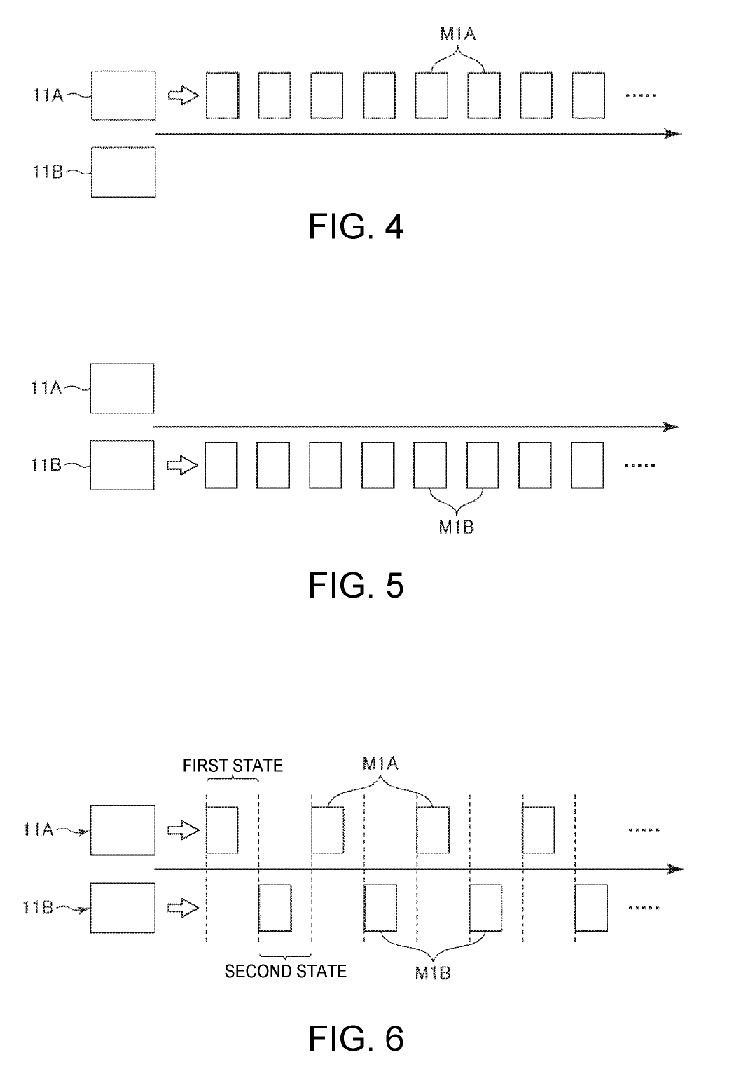

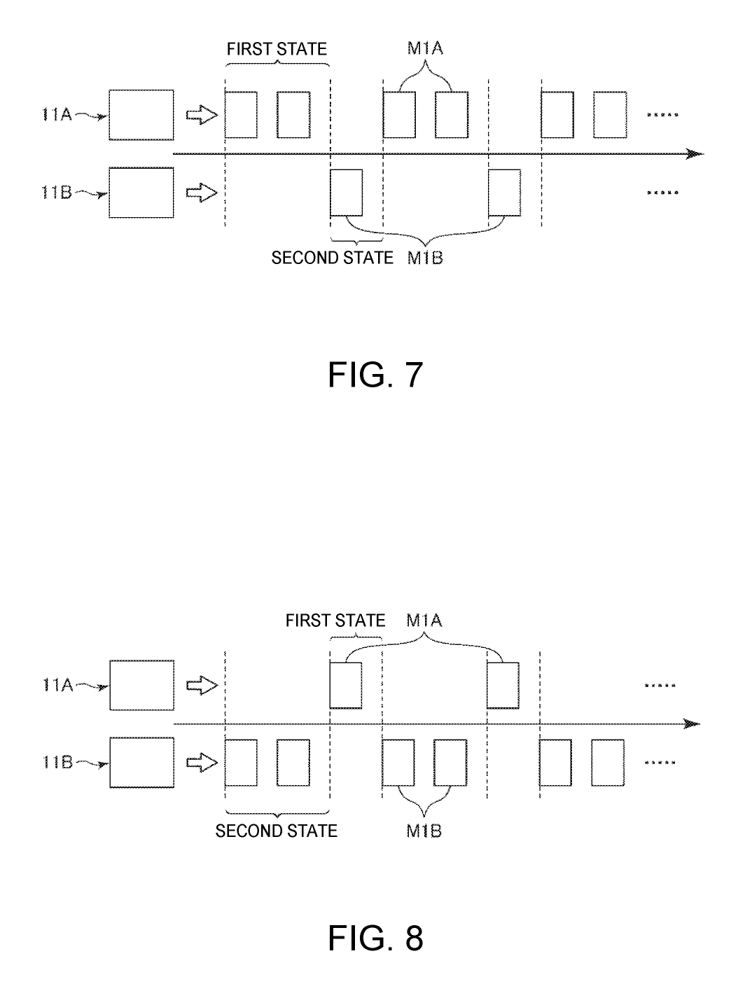

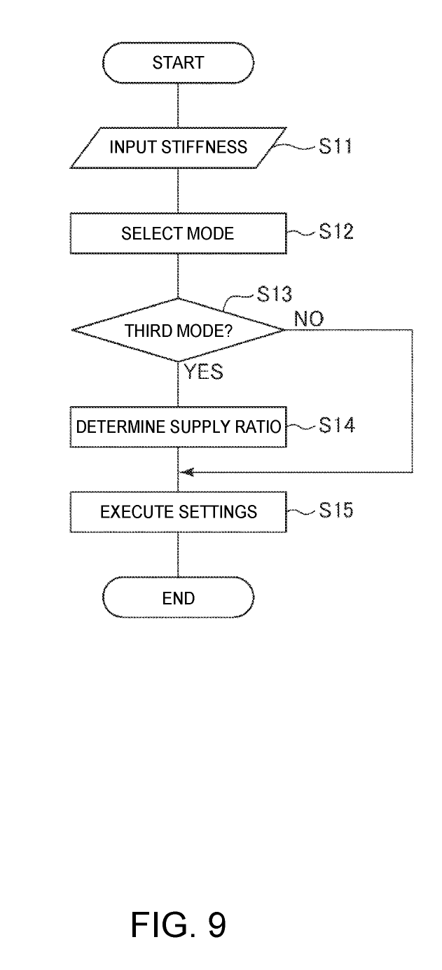

FIG. 1 schematically illustrates the configuration of a first embodiment of a sheet manufacturing apparatus according to the invention. FIG. 2 is a flow chart of processes executed by the sheet manufacturing apparatus shown in FIG. 1. FIG. 3 is a block diagram of the sheet manufacturing apparatus shown in FIG. 1. FIG. 4 is a timing chart of a first mode executed by the controller shown in FIG. 3. FIG. 5 is a timing chart of a second mode executed by the controller shown in FIG. 3. FIG. 6 is a timing chart of a third mode executed by the controller shown in FIG. 3. FIG. 7 is a timing chart of a third mode executed by the controller shown in FIG. 3. FIG. 8 is a timing chart of a third mode executed by the controller shown in FIG. 3. FIG. 9 is a flow chart describing the control operation of the controller shown in FIG. 3.

The sheet manufacturing apparatus 100 shown in FIG. 1 has a first feedstock supply device 11A (first material supply device) that supplies a first feedstock M1A (first material) containing a first fiber (fiber); a second feedstock supply device 11B (second material supply device) that supplies a second feedstock M1B (second material) containing a second fiber (fiber) with an average fiber length shorter than the average length of the first fiber; and controller 3 that controls operation of the first feedstock supply device 11A (first material supply device) and second feedstock supply device 11B (second material supply device).

Sheets S can therefore be manufactured with the desired stiffness, or more specifically, the stiffness of the sheet S can be easily adjusted, by the simple configuration of controlling operation of the first feedstock supply device 11A and second feedstock supply device 11B to set (select) whether to use the first feed stock M1A or second feedstock M1B.

As shown in FIG. 1, the sheet manufacturing apparatus 100 includes a feedstock supply device 11, a shredder 12, a defibrator 13, a classifier 14, a first web forming device 15, a cutter 16, a mixing device 17, a detangler 18, a second web forming device 19, a sheet forming device 20, a paper cutter 21, and a stacker 22. The sheet manufacturing apparatus 100 also has wetting unit 231, wetting unit 232, wetting unit 233, wetting unit 234, wetting unit 235, wetting unit 236, and controller 3. Operation of parts of the sheet manufacturing apparatus 100 is controlled by the controller 3.

As shown in FIG. 2, the sheet manufacturing method in this embodiment of the invention includes a feedstock supply process, a shredding process, a defibrating process, a classification process, a first web forming process, a cutting process, a mixing process, a detangling process, a second web forming process, a second web forming process, a sheet forming process, and a sheet cutting process.

The configuration of parts of the sheet manufacturing apparatus 100 is described next.

The feedstock supply device 11 is the part that executes the feedstock supply process (see FIG. 2) supplying feedstock M1 to the shredder 12. The feedstock M1 in this example is fiber-containing material including fiber (particularly cellulosic fiber), and in this example is in a sheet form.

Note that feedstock M1 as used herein may refer to the first feedstock M1A or second feedstock M1B supplied from the feedstock supply device 11, or to both first feedstock M1A and second feedstock M1B.

In this embodiment, the feedstock M1 (first feedstock M1A, second feedstock M1B) is recovered paper, that is, sheets that have been used, but the invention is not so limited and the feedstock M1 may be sheets that have not been used.

Note that the cellulose fiber may be any fibrous material containing mainly cellulose (narrowly defined cellulose) as a chemical compound, and in addition to cellulose (narrowly defined cellulose) may include hemicellulose or lignin.

The feedstock supply device 11 includes the first feedstock supply device 11A (first material supply device) and second feedstock supply device 11B (second material supply device) as described further below.

The shredder 12 is the part that executes the shredding process (see FIG. 2) of shredding, in air, the feedstock M1 supplied from the feedstock supply device 11. The shredder 12 has a pair of shredder blades 121 and a chute (hopper) 122.

By turning in opposite directions of rotation, the pair of shredder blades 121 shred the feedstock M1 passing therebetween, that is, cut the feedstock M1 into small shreds M2. The size and shape of the shreds M2 are preferably appropriate to the defibration process of the defibrator 13, and in this example are preferably pieces 100 mm or less on a side, and are further preferably pieces that are greater than or equal to 10 mm and less than or equal to 70 mm per side.

The chute 122 is located below the pair of shredder blades 121, and in this example is funnel-shaped. As a result, the chute 122 can easily catch the shreds M2 that are shredded and dropped by the shredder blades 121.

Above the chute 122, a wetting unit 231 is disposed beside the pair of shredder blades 121. The wetting unit 231 wets the shreds M2 in the chute 122. This wetting unit 231 has a filter (not shown in the figure) containing water, and is configured as a heaterless humidifier (or heated humidifier) that supplies a moist stream of air to the shreds M2 by passing air through the filter. By wet air being supplied to the shreds M2, shreds M2 sticking to the chute 122 due to static electricity can be suppressed.

The chute 122 connects to the defibrator 13 through a conduit (flow channel) 241. The shreds M2 collected in the chute 122 passes through the conduit 241 and are conveyed to the defibrator 13.

The defibrator 13 is the part that executes the defibrating process (see FIG. 2) that defibrates the shreds M2 (fiber-containing material including fiber) in a dry process in air. Defibrated material M3 can be produced from the shreds M2 by the defibration process of the defibrator 13.

As used herein, defibrate means to break apart and detangle into single individual fibers shreds M2 composed of many fibers bonded together. The resulting detangled fibers are the defibrated material M3. The shape of the defibrated material M3 is strings and ribbons. The defibrated material M3 may also contain clumps, which are multiple fibers tangled together into clumps.

The defibrator 13 in this embodiment of the invention, for example, is configured as an impeller mill having a rotor that turns at high speed, and a liner disposed around the rotor. Shreds M2 introduced to the defibrator 13 are defibrated between the rotor and the liner.

The defibrator 13, by rotation of the rotor, produces an air flow (current) from the shredder 12 to the classifier 14. As a result, shreds M2 can be suctioned from the conduit 241 to the defibrator 13. In addition, after the defibration process, the defibrated material M3 can be fed through another conduit 242 to the classifier 14.

The defibrator 13 also functions to separate from the fibers materials such as resin particles bonded with the defibrated material M3 (shreds M2), ink, toner, and other color material, and bleeding inhibitors.

By having a defibrator 13 that defibrates the feedstock M1 (sheet material), new sheets S (recycled paper) can be made using sheets before they are defibrated as the feedstock M1.

The defibrator 13 also connects through a conduit 242 (flow path) to the classifier 14. The defibrated material M3 (fiber-containing material after defibration) is conveyed through the conduit 242 to the classifier 14.

A blower 261 is disposed in the conduit 242. The blower 261 is an air flow generator that produces a flow of air to the classifier 14. This promotes conveyance of the defibrated material M3 to the classifier 14.

The classifier 14 is the part that executes the classification process (see FIG. 2) of classifying the defibrated material M3 based on the length of the fibers. In the classifier 14, the defibrated material M3 is separated into first screened material M4-1, and second screened material M4-2 that is larger than the first screened material M4-1. The first screened material M4-1 is of a size appropriate to manufacturing sheets S (sheet material) downstream.

The second screened material M4-2 may also include, for example, material that has not been sufficiently defibrated, and excessively agglomerated (clumped) defibrated fibers.

The classifier 14 includes a drum 141, and a housing 142 enclosing the drum 141.

The drum 141 is a sieve comprising a cylindrical mesh body that rotates on its center axis. The defibrated material M3 is introduced to the drum 141. By the drum 141 rotating, defibrated material M3 that is smaller than the mesh passes through and is separated as first screened material M4-1, and defibrated material M3 that is larger than the mesh and therefore does not pass through, is separated as second screened material M4-2.

The first screened material M4-1 drops from the drum 141.

The second screened material M4-2 is discharged to the conduit (flow path) 243 connected to the drum 141. The end of the conduit 243 on the opposite end (downstream end) as the drum 141 is connected to another conduit 241. The second screened material M4-2 that past through the conduit 243 merges with the shreds M2 inside the conduit 241, and is introduced with the shreds M2 to the defibrator 13. As a result, the second screened material M4-2 is returned to the defibrator 13 and again passes through the defibrating process with the shreds M2.

The first screened material M4-1 from the drum 141 is dispersed while dropping through air, and descends toward the first web forming device 15 (separator). The first web forming device 15 is the part that executes a first web forming process (see FIG. 2) forming a first web M5 from the first screened material M4-1. The first web forming device 15 includes a mesh belt (separation belt) 151, three tension rollers 152, and a suction unit (suction mechanism) 153.

The mesh belt 151 is an endless belt on which the first screened material M4-1 accumulates. This mesh belt 151 is mounted on three tension rollers 152. By rotationally driving the tension rollers 152, the first screened material M4-1 deposited on the mesh belt 151 is conveyed downstream.

The size of the first screened material M4-1 is greater than or equal to the size of the mesh in the mesh belt 151. As a result, passage of the first screened material M4-1 through the mesh belt 151 is limited, and as a result the first screened material M4-1 accumulates on the mesh belt 151. Furthermore, because the first screened material M4-1 is conveyed downstream by the mesh belt 151 as the first screened material M4-1 accumulates on the mesh belt 151, the first screened material M4-1 is formed in a layer as a first web M5.

The first screenings M4-1 may contain color material CM. This color material CM is smaller than the mesh of the mesh belt 151. As a result, the color material CM passes through the mesh belt 151 and precipitates.

The suction unit 153 suctions air from below the mesh belt 151. As a result, color material CM that has past through the mesh belt 151 can be suctioned together with the air.

The suction unit 153 is connected to a dust collector 27 (collection device) through another conduit (flow path) 244. Impurities suctioned by the suction unit 153 are captured by the dust collector 27.

Another conduit (flow path) 245 is also connected to the dust collector 27. A blower 262 is disposed to the conduit 245. Operation of the blower 262 produces suction in the suction unit 153. This promotes formation of the first web M5 on the mesh belt 151. The first web M5 is made from material from which color material CM has been removed. Operation of the blower 262 causes the color material CM to pass through the conduit 244 and reach the dust collector 27.

The housing 142 is connected to a wetting unit 232. Like the wetting unit 231 described above, the wetting unit 232 is a heaterless humidifier. As a result, wet air is supplied into the housing 142. This wet air moistens the first screened material M4-1, and as a result can suppress sticking of the first screened material M4-1 to the inside walls of the housing 142 due to static electricity.

Another wetting unit 235 is disposed downstream from the classifier 14. This wetting unit 235 is configured as an ultrasonic humidifier that mists water. As a result, moisture can be supplied to (can humidify or moisten) the first web M5, and the moisture content of the first web M5 can thereby be adjusted. This adjustment can also suppress sticking of the first web M5 to the mesh belt 151 due to static electricity. As a result, the first web M5 easily separates from the mesh belt 151 at the tension roller 152 from where the mesh belt 151 returns to the upstream side.

On the downstream side of the wetting unit 235 is a cutter 16. The cutter 16 is a part that executes a cutting process (see FIG. 2) of cutting the first web M5 that has separated from the mesh belt 151.

The cutter 16 has a propeller 161 that is rotationally supported, and a housing 162 that houses the propeller 161. The first web M5 is cut into pieces by the first web M5 being fed into the rotating propeller 161. The cut first web M5 becomes shreds M6. The shreds M6 then drop down in the housing 162.

The housing 162 is connected to another wetting unit 233. Like the wetting unit 231 described above, the wetting unit 233 is a heaterless humidifier. As a result, wet air is supplied into the housing 162. This wet air suppresses sticking of the shreds M6 to the propeller 161 and to the inside walls of the housing 162 due to static electricity.

A mixing device 17 is disposed on the downstream side of the cutter 16. The mixing device 17 is the part that executes a mixing process (see FIG. 2) of mixing the segments M6 with resin P1. The mixing device 17 includes a resin supply device 171, a conduit (flow path) 172, and a blower 173.

The conduit 172 connects to the housing 162 of the cutter 16 and the housing 182 of the detangler 18, and is a flow path through which a mixture M7 of the segments M6 and resin P1 passes.

The resin supply device 171 connects to the conduit 172. The resin supply device 171 has a screw feeder 174. By rotationally driving the screw feeder 174, the resin P1 can be supplied in powder or particle form to the conduit 172. The resin P1 supplied to the conduit 172 is mixed with the segments M6, forming the mixture M7.

Note that the resin P1 bonds fibers together in a downstream process, and may be a thermoplastic resin or a thermosetting resin, but is preferably a thermoplastic resin. Examples of such thermoplastic resins include AS resin, ABS resin, polyethylene, polypropylene, ethylene-vinylacetate copolymer (EVA), or other polyolefin, denatured polyolefins, polymethylmethacrylate or other acrylic resin, polyvinyl chloride, polystyrene, polyethylene terephthalate, polybutylene terephthalate or other polyesters, nylon 6, nylon 46, nylon 66, nylon 610, nylon 612, nylon 11, nylon 12, nylon 6-12, nylon 6-66 or other polyimide (nylon), polyphenylene ether, polyacetal, polyether, polyphenylene oxide, polyether ether ketone, polycarbonate, polyphenylene sulfide, thermoplastic polyimide, polyether imide, aromatic polyester, or other liquid crystal polymer, styrenes, polyolefins, polyvinyl chlorides, polyurethanes, polyesters, polyimides, polybutadienes, transpolyisoprenes, fluoroelastomers, polyethylene chlorides and other thermoplastic elastomers, as well as combinations of one or two or more of the foregoing. Preferably, a polyester or resin containing a polyester is used as the thermoplastic resin.

Additives other than resin P1 may also be supplied from the resin supply device 171, including, for example, coloring agents for adding color to the fiber, anti-blocking agents for suppressing clumping of the fiber and clumping of the resin P1, and flame retardants for making the fiber and manufactured sheets difficult to burn. Starch and other vegetable materials may also be used.

The blower 173 is disposed to the conduit 172 downstream from the resin supply device 171. The blower 173 is configured to produce an air current toward the detangler 18. This air current can also mix the segments M6 and resin P1 inside the conduit 172. As a result, the mixture M7 can be introduced to the detangler 18 as a uniform dispersion of the segments M6 and resin P1. The segments M6 in the mixture M7 are further detangled into smaller fibers while travelling through the conduit 172.

The detangler 18 is the part that executes the detangling process (see FIG. 2) that detangles interlocked fibers in the mixture M7.

The detangler 18 includes a drum 181 and a housing 182 that houses the drum 181.

The drum 181 is a sieve comprising a cylindrical mesh body that rotates on its center axis. The mixture M7 is introduced to the drum 181. By the drum 181 rotating, fiber in the mixture M7 that is smaller than the mesh can pass through the drum 181. The mixture M7 is detangled in this process.

The mixture M7 that is detangled in the drum 181 is dispersed while dropping through air, and falls to the second web forming device 19 located below the drum 181. The second web forming device 19 is the part that executes the second web forming process (see FIG. 2) forming a second web M8 from the mixture M7. The second web forming device 19 includes a mesh belt 191 (separation belt), tension rollers 192, and a suction unit 193 (suction mechanism).

The mesh belt 191 is an endless belt on which the mixture M7 accumulates. This mesh belt 191 is mounted on four tension rollers 192. By rotationally driving the tension rollers 192, the mixture M7 deposited on the mesh belt 191 is conveyed downstream.

Most of the mixture M7 on the mesh belt 191 is larger than the mesh in the mesh belt 191. As a result, the mixture M7 is suppressed from passing through the mesh belt 191, and therefore accumulates on the mesh belt 191. The mixture M7 is conveyed downstream by the mesh belt 191 as the mixture M7 accumulates on the mesh belt 191, and is formed in a layer as the second web M8.

The suction unit 193 suctions air down from below the mesh belt 191. As a result, the mixture M7 can be pulled onto the mesh belt 191, and accumulation of the mixture M7 on the mesh belt 191 is thereby promoted.

Another conduit 246 (flow path) is connected to the suction unit 193. A blower 263 is also disposed to the conduit 246. Operation of the blower 263 produces suction in the suction unit 193.

Another wetting unit 234 is connected to the housing 182. Like the wetting unit 231 described above, the wetting unit 234 is a heaterless humidifier. As a result, wet air is supplied into the housing 182. By humidifying the inside of the housing 182 by adding wet air, sticking of the mixture M7 to the inside walls of the housing 182 due to static electricity can be suppressed.

Another wetting unit 236 is disposed below the detangler 18. This wetting unit 236 is configured as an ultrasonic humidifier similarly to the wetting unit 235 described above. As a result, moisture can be supplied to the second web M8, and the moisture content of the second web M8 can thereby be adjusted. This adjustment can also suppress sticking of the second web M8 to the mesh belt 191 due to static electricity. As a result, the second web M8 easily separates from the mesh belt 191 at the tension roller 192 from where the mesh belt 191 returns to the upstream side.

A sheet forming device 20 is disposed downstream from the second web forming device 19. The sheet forming device 20 is the part that executes the sheet forming process (see FIG. 2) forming sheets S from the second web M8. This sheet forming device 20 includes a calender 201 and a heater 202.

The calender 201 comprises a pair of calender rolls 203, and compresses the second web M8 between the calender rolls 203 without heating the second web M8. This process increases the density of the second web M8. The second web M8 is then conveyed toward the heater 202. Note that one of the pair of calender rolls 203 is a drive roller that is driven by operation of a motor (not shown in the figure), and the other is a driven roller.

The heater 202 has a pair of heat rollers 204, which can heat while compressing the second web M8 between the heat rollers 204. The combination of heat and pressure melts the resin P1 in the second web M8, and binds fibers through the molten resin P1. As a result, a sheet S is formed.

The sheet S is then conveyed to the paper cutter 21. Note that one of the pair of heat rollers 204 is a drive roller that is driven by operation of a motor (not shown in the figure), and the other is a driven roller.

A paper cutter 21 is disposed downstream from the sheet forming device 20. The paper cutter 21 is the part that executes the sheet cutting process (see FIG. 3) that cuts the continuous sheet S into single sheets S. The paper cutter 21 includes a first cutter 211 and a second cutter 212.

The first cutter 211 cuts the sheet S in the direction crosswise to the conveyance direction of the sheet S.

The second cutter 212 is downstream from the first cutter 211, and cuts the sheets S in the direction parallel to the conveyance direction of the sheet S.

Sheets S of a desired size are produced by the cutting action of the first cutter 211 and the second cutter 212. The sheets S are then conveyed further downstream and stacked in a stacker 22.

As shown in FIG. 3, the controller 3 includes a CPU 31 (Central Processing Unit) and storage 32 (memory, hard disk drive, or other).

The CPU 31 controls operation of the sheet manufacturing apparatus 100. The CPU 31 controls other parts of the sheet manufacturing apparatus 100 based on programs stored in storage 32.

The storage 32 in this example is rewritable nonvolatile memory. Programs such as programs related to making sheets are stored in the storage 32, and these programs are run by the CPU 31.

As shown in FIG. 1 and FIG. 3, an operating unit 4 includes a monitor 41 and operating buttons 42. The monitor 41 in this example is an LCD screen, and various configuration screens (not shown in the figure) for configuring operation of various parts of the sheet manufacturing apparatus 100 are presented on the monitor 41.

The operating buttons 42 may be dedicated buttons, buttons on a keyboard, or virtual buttons set (formed) on a monitor 41 configured with an LCD screen, for example.

Communication between the operating unit 4 and controller 3 may be by wire or wireless, or over the Internet or other network. Communication between the feedstock supply device 11 and controller 3 may be by wire or wireless, or over the Internet or other network.

By operating the operating buttons 42 while viewing the monitor 41, the operator can make various settings on the configuration screens.

In addition, by operating the operating unit 4 of the sheet manufacturing apparatus 100, the stiffness of the sheets S that are made can be selected from multiple levels as described further below.

The sheet manufacturing apparatus 100 according to the invention is a configuration enabling adjusting the stiffness of the manufactured sheets S, enabling producing sheets S with the desired stiffness, that is, the set (selected) stiffness. This is described further below.

Note that stiffness as used herein refers to the strength of the flexural rigidity of the sheet (that is, the strength (or degree) of the stiffness), and the strength of the resistance of the sheet to tearing. Stiffness also depends on the average length of the fibers, the thickness of the sheet, and the content (amount) and types of resin P1, but for simplicity, is described as simply depending on the average length of the fibers.

As shown in FIG. 1, the feedstock supply device 11 has a first feedstock supply device 11A (first material supply device) and a second feedstock supply device 11B (second material supply device).

The first feedstock supply device 11A is loaded with paper as the first feedstock M1A (first material), and the second feedstock supply device 11B is loaded with paper as the second feedstock M1B (second material).

The first feedstock M1A and second feedstock M1B differ by the average length of the fibers, and the average fiber length of the first feedstock M1A is longer than the average fiber length of the second feedstock M1B. As a result, the stiffness of the paper supplied as the first feedstock M1A is relatively high, and the stiffness of the paper supplied as the second feedstock M1B is relatively low in this example.

Note that the average length of the fibers is the average length of a random number of selected fibers and measured by a transmission electron microscope (TEM). Note that “long” and “short” are relative terms comparing fibers of the first feedstock M1A and fibers of the second feedstock M1B. Differences in the average length of the fiber in the first feedstock M1A and the fiber in the second feedstock M1B may result, for example, from the number of times sheets S are made (recycled) by the sheet manufacturing apparatus 100.

The paper of the first feedstock M1A and the paper of the second feedstock M1B are effectively the same thickness and size (the size in plan view). However, the invention is not so limited, and the paper of the first feedstock M1A and the paper of the second feedstock M1B may be different thicknesses or size.

The first feedstock M1A stocked in the first feedstock supply device 11A may all be the same thickness or size, or may vary in thickness or size.

The first feedstock supply device 11A and second feedstock supply device 11B are electrically connected to the controller 3, and operation thereof is controlled by the controller 3. The first feedstock supply device 11A and second feedstock supply device 11B each have a hopper in which the feedstock paper is stocked, and a power source such as a motor, and when the power source is driven, feed the first feedstock M1A or second feedstock M1B one sheet at a time. The controller 3 controls (supplies power) to the first feedstock supply device 11A and second feedstock supply device 11B according to the stiffness setting made by the operator.

The controller 3 of the sheet manufacturing apparatus 100 controls operation in a first mode, second mode, or third mode. Programs corresponding to each mode are stored in the storage 32.

### First Mode

As shown in FIG. 4, only first feedstock M1A from the first feedstock supply device 11A is supplied in the first mode. More specifically, second feedstock M1B from the second feedstock supply device 11B is not supplied in the first mode.

Because in the first mode only first feedstock M1A containing fiber with a relatively long fiber length (first fiber) is supplied to the defibrator 13, the average fiber length of the defibrated material M3 is relatively long. As a result, the average length of the fibers in the sheet S becomes relatively long. As a result, sheets S with relatively high stiffness can be produced in the first mode.

Note that in the first mode in this embodiment, the first feedstock M1A is supplied to the shredder 12 at a regular interval. More specifically, in the first mode the first feedstock M1A is supplied at a constant speed to the shredder 12.

### Second Mode

As shown in FIG. 5, only second feedstock M1B from the second feedstock supply device 11B is supplied in the second mode. More specifically, first feedstock M1A from the first feedstock supply device 11A is not supplied in the second mode.

Because in the second mode only second feedstock M1B containing fiber with a relatively short fiber length (second fiber) is supplied to the defibrator 13, the average fiber length of the defibrated material M3 is relatively short. As a result, the average length of the fibers in the sheet S becomes relatively short. As a result, sheets S with relatively low stiffness can be produced in the second mode.

Note that the first fiber and second fiber are fibers of the same material. That is, the first fiber and second fiber are fibers made from the same material.

Note that in the second mode in this embodiment, the second feedstock M1B is supplied to the shredder 12 at a regular interval. More specifically, in the second mode the second feedstock M1B is supplied at a constant speed to the shredder 12.

As described above, the control modes of the sheet manufacturing apparatus 100 include a first mode for supplying first feedstock M1A (first material) from the first feedstock supply device 11A (first material supply device), and a second mode for supplying second feedstock MB (second material) from the second feedstock supply device 11B (second material supply device), and the controller 3 selects either the first mode or the second mode. As a result, making sheets S with relatively high stiffness, or making sheets S with relatively low stiffness, can be selected according to the stiffness setting of the sheet S input by the operator.

### Third Mode

As shown in FIG. 6 to FIG. 8, the sheet manufacturing apparatus 100 also has a third mode as a control mode for supplying material from both the first feedstock supply device 11A (first material supply device) and second feedstock supply device 11B (second material supply device). More specifically, the third mode is a mode for making sheets S using both first feedstock M1A and second feedstock M1B. As a result, sheets S with stiffness between the stiffness of sheets S made in the first mode and the stiffness sheets S made in the second mode can be made.

In this third mode feedstock can be supplied in a first state supplying only first feedstock M1A, a second state supplying only second feedstock M1B, and a state supplying both first material and second material simultaneously or at offset times.

In the third mode, the controller 3 repeatedly switches between the first state supplying first feedstock M1A (first material) from the first feedstock supply device 11A (first material supply device), and the second state supplying second feedstock M1B (second material) from the second feedstock supply device 11B (second material supply device).

As a result, the first web M5 formed on the mesh belt 151 in the third mode contains defibrated material of fiber with an average fiber length that is relatively long and defibrated material of fiber with an average fiber length that is relatively short laid alternately in the conveyance direction of the first web M5. This state (tendency) of fiber lengths alternating in the conveyance direction of the sheet is mitigated by the time the defibrated material reaches the mesh belt 191, that is, in the second web M8 laid on the mesh belt 191. As a result, uniform stiffness can be assured in each sheet of paper (sheet S). Formation of areas with high stiffness and areas with low stiffness in a single sheet of paper (sheet S) can also be prevented as much as possible.

Based on the settings made by the operator, the controller 3 can adjust the stiffness of the manufactured sheets S in multiple levels by adjusting a first supply volume indicating the amount of first feedstock M1A supplied, and the second supply volume indicating the amount of second feedstock M1B supplied. This is described further in the following example in which the supply of material is adjusted in five levels. In order from highest to lowest sheet S stiffness, these levels are referred to below as rank A (highest stiffness) to rank B, rank C, rank D, and rank E (lowest stiffness).

Sheets S of rank A are made in the first mode described above (see FIG. 4), and sheets S of rank E are made in the second mode described above (see FIG. 5).

As shown in FIG. 7, a sheet S of rank B is made in the third mode with the supply ratio of first feedstock M1A to second feedstock M1B 2:1.

As shown in FIG. 6, a sheet S of rank C is made in the third mode with the supply ratio of first feedstock M1A to second feedstock M1B 1:1.

As shown in FIG. 8, a sheet S of rank D is made in the third mode with the supply ratio of first feedstock M1A to second feedstock M1B 1:2.

The controller 3 determines the amount of first feedstock M1A and second feedstock M1B to supply based on the operator operating the operating unit 4 to select one of rank A, rank B, rank C, rank D and rank E. As a result, sheets S of the desired stiffness can be made. In other words, the controller 3 determines the supply (first supply volume) of first feedstock M1A, and the supply (second supply volume) of second feedstock M1B, according to the stiffness of the sheets S to make. The sheets S that are made therefore have the specified stiffness.

In the third mode, the first supply volume of the first feedstock M1A (first material) in the first state, and the second supply volume of the second feedstock M1B (second material) in the second state, can be set separately. As a result, the supply ratio of the first feedstock M1A and second feedstock M1B can be adjusted in multiple levels. The stiffness of the sheets S that are made can therefore be adjusted in multiple levels.

The supply ratio as used here means the ratio between the amount (number of sheets) of first feedstock M1A supplied at one time in the first state, and the amount (number of sheets) of second feedstock M1B supplied at one time in the second state, in a configuration that repeatedly alternates between the first state and second state. The supply ratio may also refer to the sum (total) amount of first feedstock M1A supplied in all first states, and the sum (total) amount of second feedstock M1B supplied in all second states.

In this example, the first feedstock M1A (first material) and second feedstock M1B (second material) are sheet materials, and the controller 3 adjusts the first supply volume and second supply volume based on the number of sheets. As a result, adjusting the stiffness of the sheets being made can be easily controlled by setting the number of sheets fed into the shredder 12.

In this embodiment, in the third mode, the supply of first feedstock M1A in the first state and the supply of second feedstock M1B in the second state alternate at a specific time interval. In other words, regardless of the operating mode, the first feedstock M1A or second feedstock M1B is supplied at a constant speed to the shredder 12.

The control operation of the controller 3 before supplying the first feedstock M1A or second feedstock M1B starts is described next with reference to the flow chart in FIG. 9.

First, in step S11, the operator selects (inputs) through the operating unit 4 the stiffness of the sheets S to make. In this example, the operator selects rank A, rank B, rank C, rank D or rank E described above.

Next, in step S12, the first mode, second mode, or third mode is selected according to the range (mode) selected in step S11.

As described above, the first mode is selected when rank A is selected, the second mode is selected when rank E is selected, and the third mode is selected when rank B, rank C or rank D is selected.

The controller 3 thus sets the mode to execute according to the stiffness of the sheets S to make. As a result, the sheets S that are made can be made with the specified stiffness.

Next, in step S13, the controller 3 determines if the selected mode is the third mode. If the selected mode is the first mode or second mode, control goes to step S15.

If the selected mode is the third mode, in step S14 the controller 3 determines the ratio between the first feedstock M1A and second feedstock M1B. The supply ratio can be set based on a table that relates supply ratios to ranks and is stored in the storage 32.

Supplying first feedstock M1A or second feedstock M1B then starts in step S15 at the settings set by step S14.

As described above, a sheet manufacturing apparatus 100 according to the invention has a first feedstock supply device 11A (first material supply device) that supplies first feedstock M1A (first material) containing fiber, a second feedstock supply device 11B (second material supply device) that supplies second feedstock M1B (second material) containing fiber with an average length shorter than the average length of the fibers in the first material, and a controller 3 that controls operation of the first feedstock supply device 11A (first material supply device) and second feedstock supply device 11B (second material supply device).

As a result, sheets S can be made with the desired stiffness, that is, the stiffness of the sheets S can be easily adjusted, by the simple configuration of controlling operation of the first feedstock supply device 11A and second feedstock supply device 11B and using at least one of a first feedstock M1A and second feedstock M1B.

Methods of the related art for adjusting the stiffness of the sheet S being made involves a process of disposing a layer of an alkaline digestible biodegradable plastic on the surface of the recycled paper. The present invention omits this complicated process and can easily adjust the stiffness of the sheet S.

### Embodiment 2

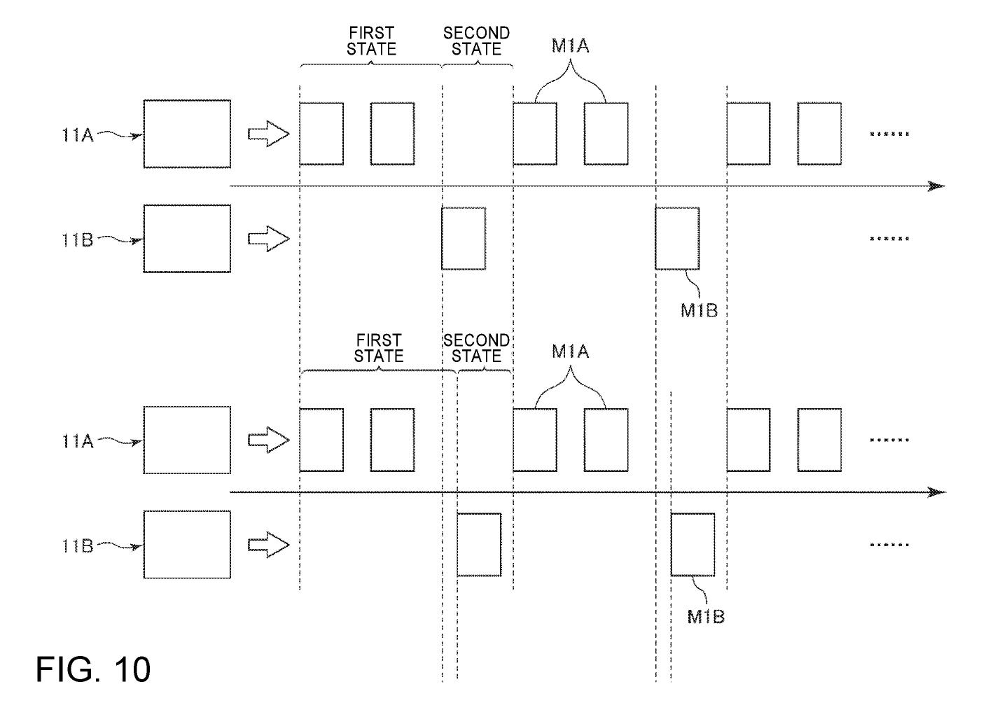

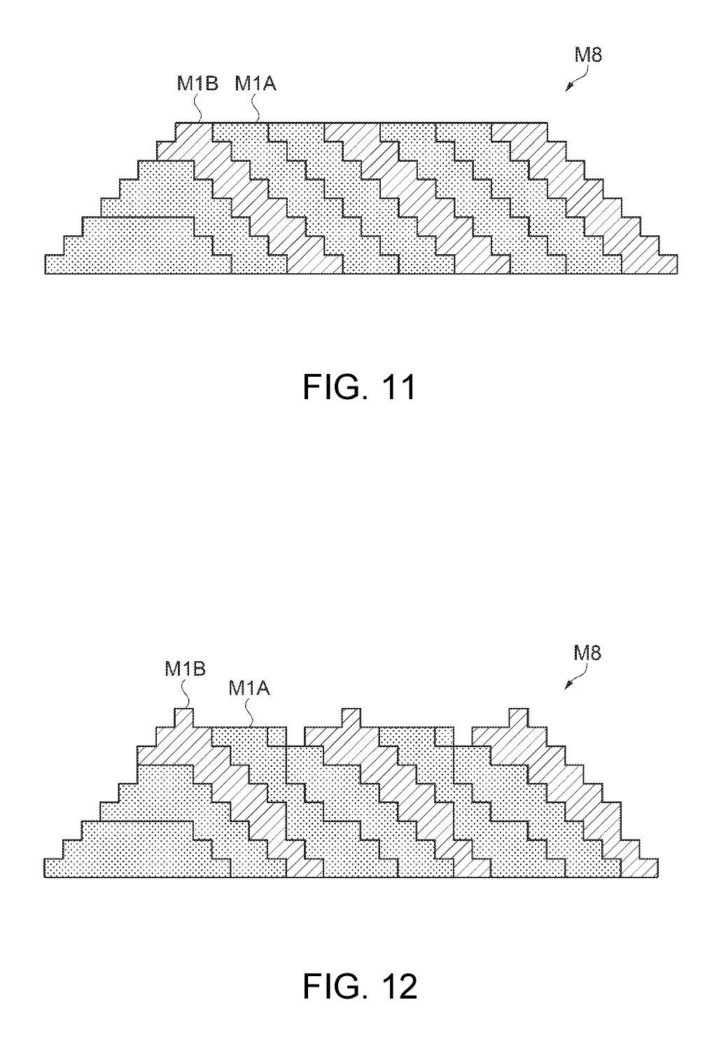

FIG. 10 is a timing chart of a third mode executed by the controller of a sheet manufacturing apparatus according to the second embodiment of the invention. FIG. 11 is a vertical section view schematically illustrating a second web. FIG. 12 is a vertical section view schematically illustrating a second web.

A second embodiment of a sheet manufacturing apparatus according to the invention is described below with reference to the accompanying figures, focusing on the differences between this and the foregoing embodiment, and omitting or simplifying further description of like elements.

This embodiment is the same as the first embodiment except for the control operation in the third mode.

FIG. 10 shows the supply timing of the first feedstock M1A and second feedstock M1B when making a sheet S of rank B in the third mode.

Of the two timing charts in FIG. 10, the timing chart on the top is a timing chart for supplying first feedstock M1A or second feedstock M1B at a constant speed as described in the first embodiment.

When first feedstock M1A or second feedstock M1B is supplied at a constant speed, and the difference between the average fiber lengths of the first feedstock M1A and second feedstock M1B is relatively great, the events described below may occur. Note that the difference between the average fiber lengths of the first feedstock M1A and second feedstock M1B can be estimated from the number of times the first feedstock M1A and second feedstock M1B have been recycled, and is previously known to the operator.

For example, second feedstock M1B containing fiber with a relatively short fiber length tends to pass more quickly through the drum 181 of the detangler 18 than first feedstock M1A containing fiber with a relatively long fiber length. As a result, as shown in FIG. 12, the defibrated material of the second feedstock M1B tends to accumulate excessively on some parts and insufficiently on other parts of the defibrated material of the first feedstock M1A laid on the mesh belt 191, resulting in uneven thickness in the second web M8. When the second web M8 thus formed passes through the sheet forming device 20, uneven (inconsistent) stiffness results in the final sheet S. Note that the direction from left to right in FIG. 12 (and FIG. 11) is the conveyance direction of the second web M8.

Of the two timing charts shown in FIG. 10, the timing for supplying second feedstock M1B in the second state shown in the bottom timing chart is delayed from the supply timing of the timing chart on top. As a result, as shown in FIG. 11, the thickness of the second web M8 formed on the mesh belt 191 can be made as uniform as possible. By passing the second web M8 thus formed through the sheet forming device 20, variation in the stiffness of the final sheet S can be suppressed.

Note that this embodiment describes a configuration for adjusting the supply timing of the second feedstock M1B in the second state, but may be configured to adjust the supply timing of the first feedstock M1A in the first state, or to adjust the supply timing of both the first feedstock M1A and the second feedstock M1B.

As described above, in the third mode, the controller 3 can adjust the timing for supplying the first feedstock M1A (first material) in the first state, and the timing for supplying the second feedstock M1B (second material) in the second state, according to the average fiber length of the first fiber and the average fiber length of the second fiber. As a result, stiffness can be made as uniform as possible across the surface of the sheets S that are made.

### Embodiment 3

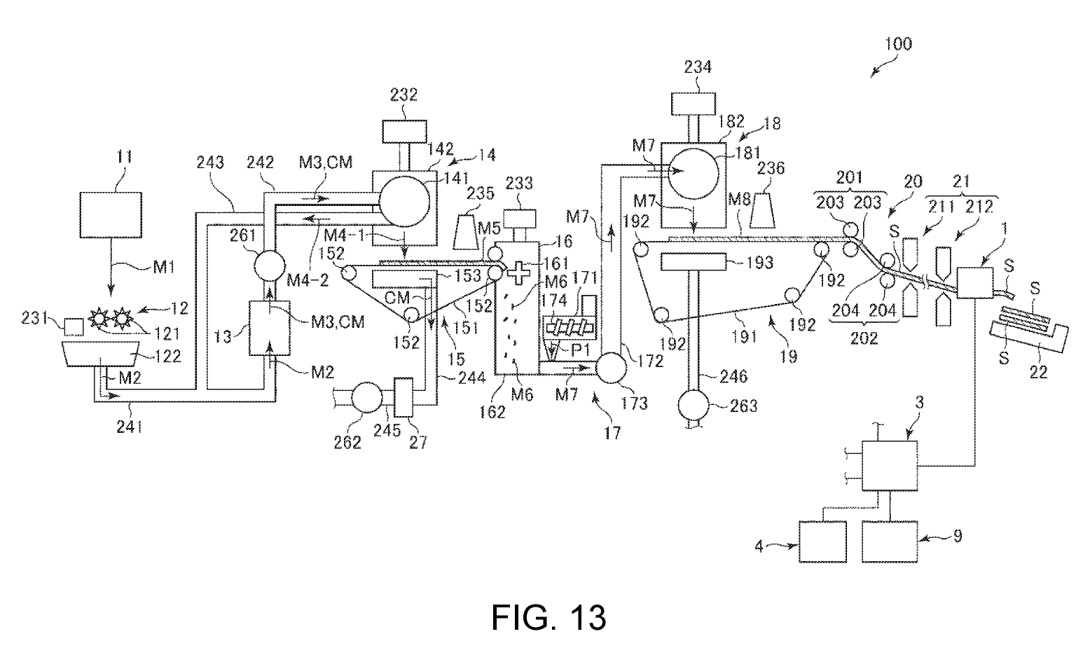

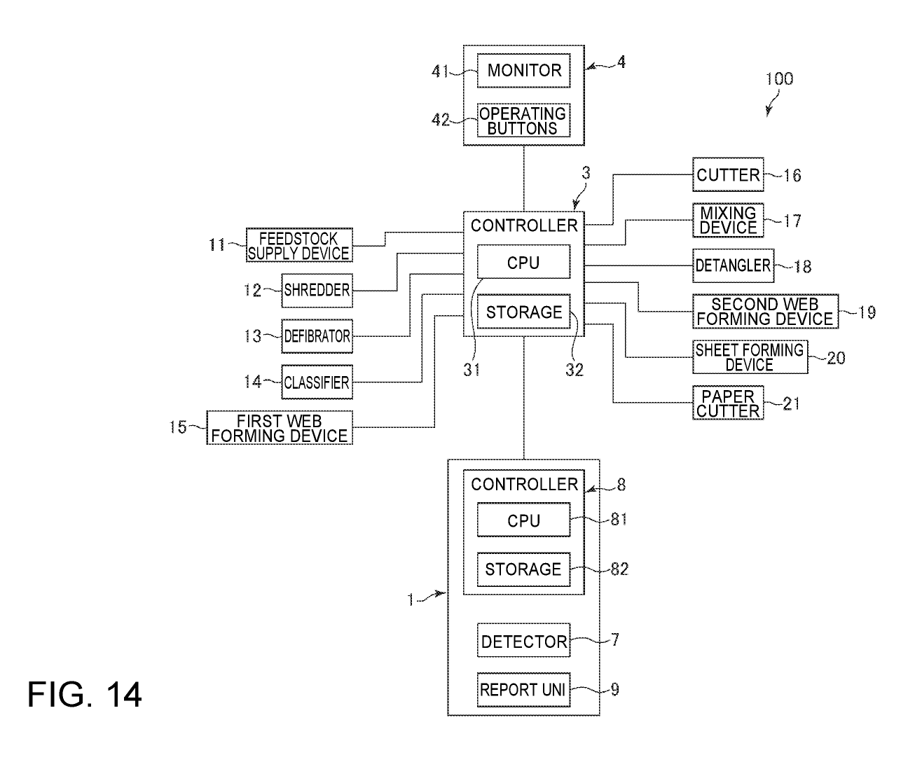

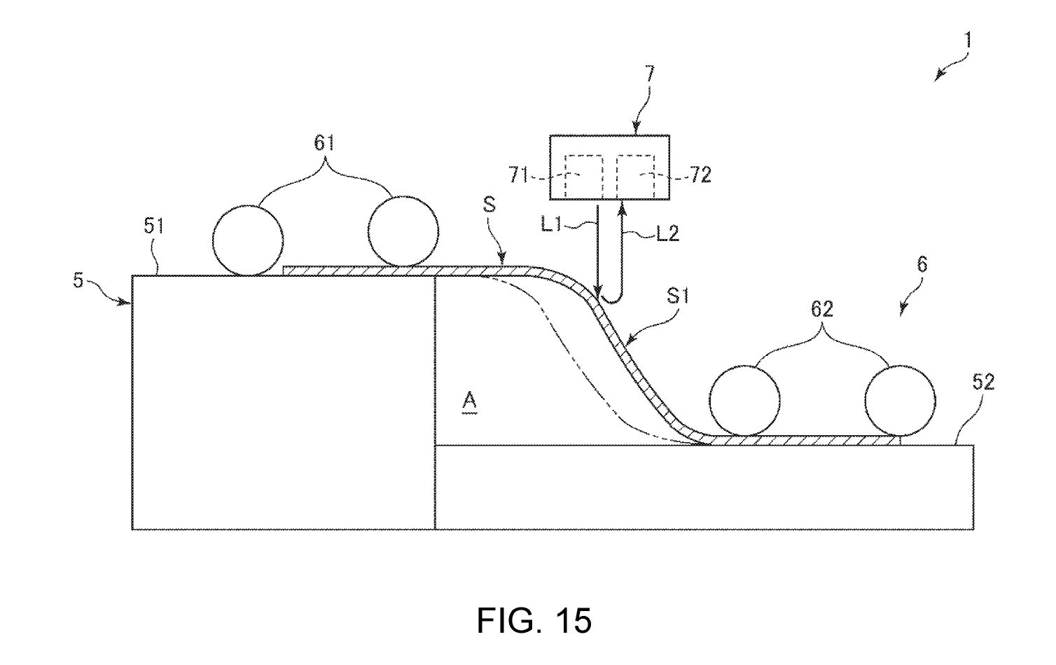

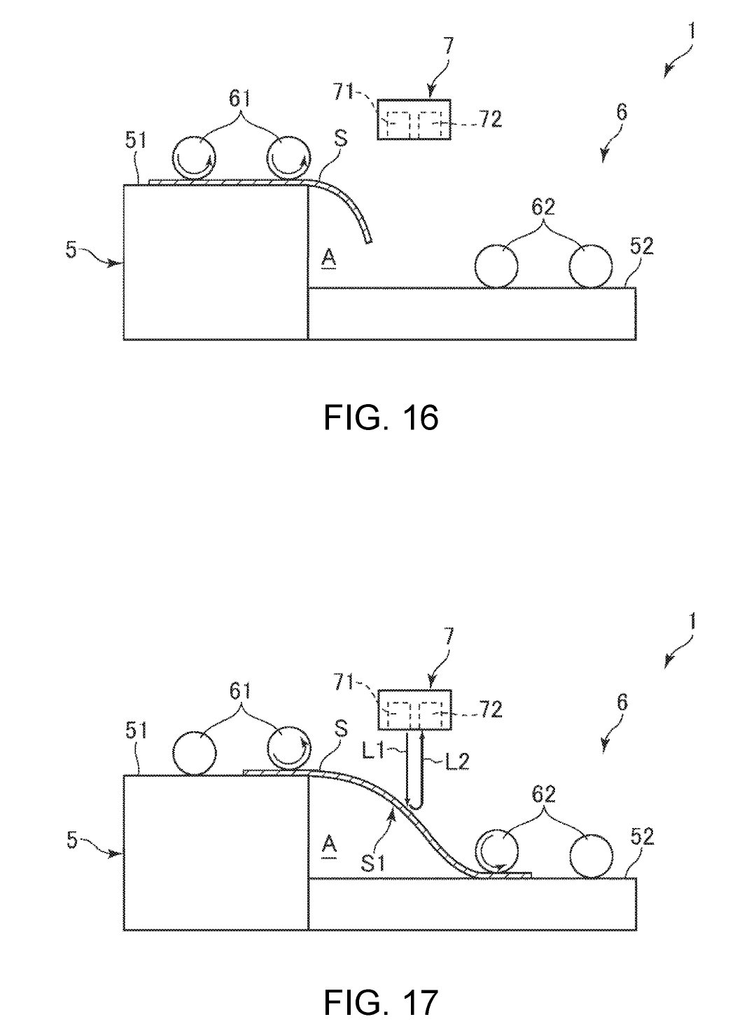

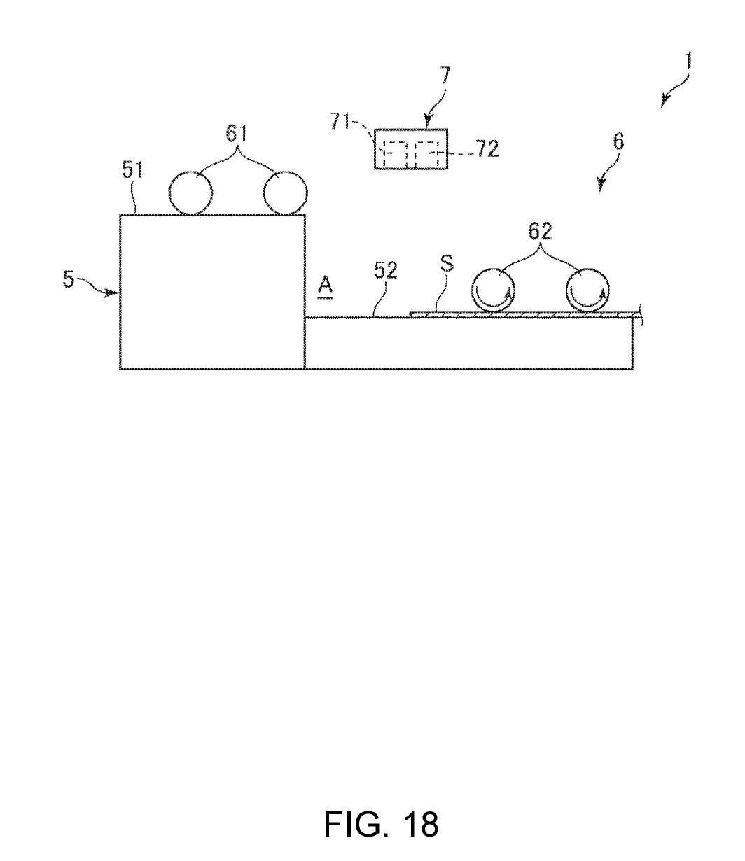

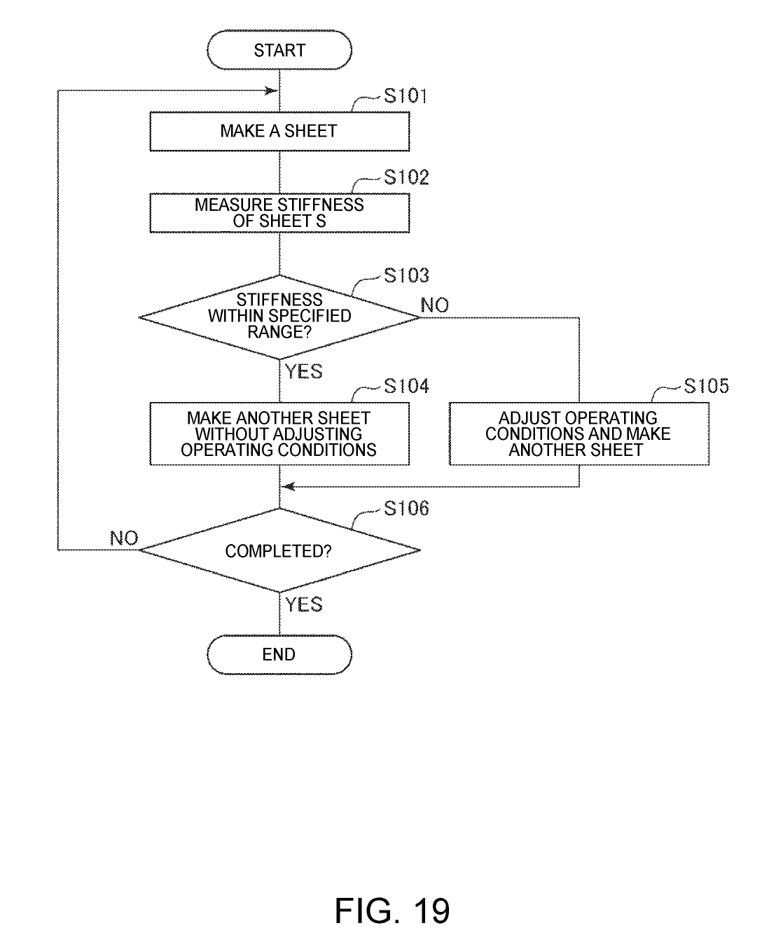

FIG. 13 schematically illustrates the configuration of a third embodiment of a sheet manufacturing apparatus according to the invention. FIG. 14 is a block diagram of the sheet manufacturing apparatus shown in FIG. 13. FIG. 15 schematically illustrates a stiffness tester according to a third embodiment of the invention. FIG. 16 illustrates an operating state of the stiffness tester shown in FIG. 15. FIG. 17 illustrates an operating state of the stiffness tester shown in FIG. 15. FIG. 18 illustrates an operating state of the stiffness tester shown in FIG. 15. FIG. 19 is a flow chart of the control operation of the controller shown in FIG. 13.

The stiffness tester 1 shown in FIG. 13 and FIG. 14 to FIG. 18 has a space A that allows deformation of the sheet S, a detector 7 that detects the deformation of the sheet S (sheet material) in the space A, and a controller 8 (evaluator) that determines the stiffness of the sheet S (sheet material) based on the output from the detector 7. As a result, the stiffness of the sheets S made by the sheet manufacturing apparatus 100, or the stiffness of the feedstock M1 supplied to the sheet manufacturing apparatus 100, can be measured. Based on the results of these measurements, the operation of the sheet manufacturing apparatus 100 can then be adjusted.

The sheet manufacturing apparatus 100 shown in FIG. 13 has a stiffness tester 1. More specifically, the sheet manufacturing apparatus 100 has a stiffness tester 1 that has a space A into which the sheet S can deform (sag), and a detector 7 that detects the deformation (sagging) of the sheet S (sheet material) in the space A, and determines the stiffness of the sheet S (sheet material) based on the output of the detector 7.

This embodiment of the invention enables making use of the benefits of the stiffness tester 1 described above to manufacture (recycle) sheets S with consistent thickness.

The sheet manufacturing apparatus 100 shown in FIG. 13 includes a stiffness tester 1, a feedstock supply device 11, a shredder 12, a defibrator 13, a classifier 14, a first web forming device 15, a cutter 16, a mixing device 17, a detangler 18, a second web forming device 19, a sheet forming device 20, a paper cutter 21, and a stacker 22. The sheet manufacturing apparatus 100 also has wetting unit 231, wetting unit 232, wetting unit 233, wetting unit 234, wetting unit 235, wetting unit 236, controller 3, operating unit 4, and report unit 9. Operation of parts of the sheet manufacturing apparatus 100 is controlled by the controller 3.

As shown in FIG. 2, the sheet manufacturing method according to this embodiment of the invention includes a feedstock supply process, a shredding process, a defibrating process, a classification process, a first web forming process, a cutting process, a mixing process, a detangling process, a second web forming process, a second web forming process, a sheet forming process, and a sheet cutting process.

A second embodiment of a sheet manufacturing apparatus according to the invention is described below with reference to the accompanying figures, focusing on the differences between this and the foregoing embodiment, and omitting or simplifying further description of like elements.

As shown in FIG. 14, the controller 3 in this embodiment of the invention includes a CPU 31 (processor) and storage 32 (memory, hard disk drive, or other). The controller 3 may be disposed at a desired location in the sheet manufacturing apparatus 100, or it may be an external device. In this case, communication between the controller and the sheet manufacturing apparatus 100 may be by wire or wireless, or over the Internet or other network. Further alternatively, configurations in which only one of the CPU 31 and storage 32 is an external device are also conceivable.

The stiffness tester 1 according to the invention is described next.

As shown in FIG. 13, the stiffness tester 1 measures the stiffness of sheet material (in this embodiment, the sheets S manufactured by the sheet manufacturing apparatus 100).

Note that stiffness as used herein refers to the strength of the flexural rigidity of the sheet (that is, the strength (or degree) of the stiffness), and the strength of the resistance of the sheet to tearing. Stiffness also depends on the average length of the fibers, the thickness of the sheet, and the content (amount) and types of resin P1, for example.

The stiffness tester 1 is disposed between the paper cutter 21 and stacker 22, and in this example measures the stiffness of the manufactured sheets S (sheet material). As a result, the operating conditions of the sheet manufacturing apparatus 100 can be adjusted according to the detected stiffness of the sheets S.

Note that the stiffness tester 1 may be disposed to measure the stiffness of the sheet S before the sheet S is cut. In this case, the stiffness tester 1 may be disposed between the calender 201 and heater 202, or between the heater 202 and paper cutter 21.

As shown in FIG. 15 to FIG. 18, the stiffness tester 1 the stiffness tester 1 has a platform 5, conveyance rollers 6 disposed above the platform 5, and the detector 7.

The platform 5 is stepped, and has a first surface 51, and a second surface 52 disposed at an elevation lower than the first surface 51. The first surface 51 is positioned upstream from the second surface 52 in the conveyance direction of the sheet S. The normals to the first surface 51 and second surface 52 are aligned with the vertical axis.

The stepped structure of the platform 5 creates a space A that allows deformation of the sheet S, that is, allows the sheet S to sag. Part of the space A is also part of the conveyance path of the sheet S.

The conveyance rollers 6 include a pair of first conveyance rollers 61 disposed above the first surface 51, and a pair of second conveyance rollers 62 disposed above the second surface 52. At least one of the pair of first conveyance rollers 61 is a drive roller driven by operation of a motor (not shown in the figure), and the other roller is a driven roller. In addition, at least one of the pair of second conveyance rollers 62 is a drive roller driven by operation of a motor (not shown in the figure), and the other roller is a driven roller. The drive rollers are electrically connected to the controller 8 (see FIG. 14), which controls drive roller operation.

The operating conditions (such as speed of rotation) of the first conveyance rollers 61 and second conveyance rollers 62 are not specifically limited, but as described below are set to apply to the sheet S tension that allows the sheet S to sag in space A.

The sheet S supplied (passing through) the stiffness tester 1 is first held between the pair of first conveyance rollers 61 and the first surface 51 and conveyed by the first conveyance rollers 61 as shown in FIG. 16. The sheet S then travels from the downstream end thereof to the second surface 52 side.

Next, as shown in FIG. 17, the downstream end of the sheet S goes between the second conveyance rollers 62 and the second surface 52, and is held therebetween. This results in the upstream end of the sheet S being held between the pair of first conveyance rollers 61 and the first surface 51, and the downstream end being held between the pair of second conveyance rollers 62 and the second surface 52. When the sheet S is thus held, the middle of the sheet S between the first conveyance rollers 61 and second conveyance rollers 62 sags due to its own weight in the space A, creating a deformed portion S1.

As shown in FIG. 17, as deformed portion S1 is then measured by the detector 7 as described below, the sheet S is held between the pair of second conveyance rollers 62 and the second surface 52, conveyed downstream, and discharged. The discharged sheet S is then deposited in the stacker 22 as shown in FIG. 13.

The detector 7 detects the deformation in the deformed portion S1 of the sheet S. More specifically, the detector 7 detects the distance to the deformed portion S1. The detector 7 is disposed above the second surface 52. In this example, the detector 7 is an optical sensor comprising an emitter 71 and a photodetector 72.

The emitter 71 may be a light-emitting diode, a laser beam generator, or an infrared beam generator, for example. The photodetector 72 may be a photodiode, for example.

The emitter 71 emits a light beam L1 toward the sheet S, and as shown in FIG. 15 and FIG. 17, the light beam L1 emitted by the emitter 71 is reflected by the deformed portion S1 as reflection L2. The photodetector 72 detects the reflection L2.

If the stiffness of the sheet S is relatively high, the sag in the sheet S caused by the weight of the sheet S is relatively small as indicated by the solid lines in FIG. 15. In this case, the distance to the deformed portion S1 is relatively short, and the strength of the reflection L2 detected by the photodetector 72 is relatively high.

However, if the stiffness of the sheet S is relatively low, the sag in the sheet S caused by the weight of the sheet S is relatively great as indicated by the dot-dot-dash line in FIG. 15. In this case, the distance to the deformed portion S1 is relatively long, and the strength of the reflection L2 detected by the photodetector 72 is relatively low.

The sag in the sheet S can be measured based on phase information about the light in the light beam L1 emitted by the emitter 71 and the reflection L2 from the deformed portion S1.

The detector 7 is electrically connected to the controller 8, and the detection result of the detector 7 (a signal including information about the light intensity detected by the photodetector 72, or information about the phase of the detected light) is sent to the controller 8.

As shown in FIG. 14, the controller 8 (evaluator) includes a CPU 81 (processor) and storage 82 (memory, hard disk drive, or other), and evaluates the stiffness of the sheet S (sheet material).

Programs such as programs related to stiffness measurements are stored in the storage 82, and these programs are run by the CPU 81.

A detection curve or table relating the detected light intensity to the stiffness of the sheet S is also stored in the storage 82. Based on the detection curve or table, the CPU 81 can determine the stiffness of the sheet S from the detected light intensity or phase information received from the detector 7.

The controller 8 of the stiffness tester 1 is electrically connected to the controller 3 of the sheet manufacturing apparatus 100, and controller 8 can send to controller 3 a signal including information about the stiffness of the sheet S. Communication between controller 8 and controller 3 may be by wire or wireless, or through the Internet or other network.

The stiffness tester 1 is configured as a unit having the platform 5, conveyance rollers 6, detector 7, and controller 8 housed in a case (not shown in the figure) having an entrance and an exit. The stiffness tester 1 and case are preferably removably installed to a desirable position in the sheet manufacturing apparatus 100. As a result, as described in the following embodiments, the stiffness tester 1 may be installed on the feedstock supply device 11 side as described below.

Note that the controller 8 may be omitted from the stiffness tester 1. In this case, the motor of the conveyance rollers 6 and the detector 7 are connected to the controller 3, and operation thereof is preferably controlled by the controller 3. In this case, light intensity or phase information, and a sheet S stiffness detection curve or table, are stored in the storage 32.

As described above, the detector 7 is an optical device that measures deformation in the sheet S (sheet material). As a result, the distance to the deformation can be detected by an accurate and simple configuration.

The detector 7 also detects deformation from the sheet S (sheet material) sagging of its own weight. As a result, applying an excessive external force to the sheet S to make the sheet S sag can be prevented. A drop in the quality (stiffness or appearance) of the sheet S can be prevented.

The stiffness tester 1 also has a report unit 9 that reports the detection result of the detector 7. If the stiffness of the manufactured sheet S is outside a desirable range, this can be reported to the operator as described below.

The report unit 9 may be a video monitor, signal lamp, speaker, or any other appropriate device having the ability to report information to the operator.

The report unit 9 is electrically connected to the controller 8, and is controlled thereby. Note that the report unit 9 may be electrically connected to the controller 3 and its operation controlled thereby.

Communication between the report unit 9 and controller 3 may be by wire or wireless, or through a network such as the Internet.

The stiffness tester 1 may also be configured to continuously measure the stiffness of the sheet S during sheet conveyance, or in a batch configuration that measures the stiffness by pausing conveyance as illustrated in FIG. 17.

As described above, a stiffness tester 1 includes a space A that allows the sheet S to deform and a detector 7 that measures deformation of the sheet S in the space A, and determines the stiffness of the sheet S from the output of the detector 7. As a result, the stiffness of the sheet S can be detected, and the operating conditions of the sheet manufacturing apparatus 100 can be set based on the detected result. The control operation of the controller 3 is described below based on the flow chart shown in FIG. 19.

First, in step S101, sheet S production starts using the operating conditions set according to the stiffness set by the operator.

Next, in step S102, the stiffness of the manufactured sheet S is determined (evaluated). As described above, this measurement is based on the light intensity or phase state detected by the photodetector 72.

Next, in step S103, the controller 3 determines whether or not the stiffness determined in step S102 is within a previously set stiffness range. If the stiffness determined is within the previously set stiffness range, sheet S production continues in step S104 without changing the settings of the operating conditions that were set in step S101.

However, if in step S103 the controller 3 determines the stiffness is not within the previously set stiffness range, in step S105 the controller 3 changes the settings of the operating conditions that were set in step S101, and makes another sheet S.

In this example, the amount of resin P1 supplied by the resin supply device 171 is adjusted. For example, if the stiffness of the sheet S is below the stiffness range previously set in step S101, the supply of resin P1 is increased from the level set in step S101. If the stiffness of the sheet S is above the stiffness range previously set in step S101, the supply of resin P1 is decreased from the level set in step S101.

The sheet manufacturing apparatus 100 in this embodiment thus has a defibrator 13 that defibrates the feedstock M1 (sheet material), and a resin supply device 171 that supplies resin P1 (resin material) to the defibrated material M3, and the controller 3 adjusts the amount of resin P1 (resin material) supplied by the resin supply device 171. As a result, the stiffness of the sheets S made after the sheet S of which the stiffness was measured can be kept within the previously set range, and sheets S with the desired stiffness can be made. More specifically, stiffness can be adjusted by the simple method of adjusting the supply of resin P1.

By having a controller 3 that adjusts the operating conditions of the sheet manufacturing apparatus 100 according to the stiffness determined by the stiffness tester 1, that is, the stiffness detected by the detector 7, sheets S with the desired stiffness can be made.

Next, in step S106, the controller 3 determines if sheet S production was completed. More specifically, the controller 3 determines if the number of sheets S that were made has reached the set count, and if the specified count has not been reached, returns to step S101, makes another sheet S, and continues the process. When the specified count has been reached, the process ends.

Note that the amount of resin supplied can be adjusted by the control operation described below, for example.

If Kdef=1.0 is the standard (target) stiffness of the sheet S, Qdef is the amount of resin supplied to achieve the standard stiffness, and the measured stiffness K is 1.2, the correction value K/Kdef=1.2. The standard resin supply Qdef is then divided by the correction amount, and the resin supply after correction can be set in this example to Qdef/1.2=0.833×Qdef.

A similar control operation can be applied to adjust the conveyance speed of the second web M8 or the conveyance speed of the defibrated material M3.

### Embodiment 4

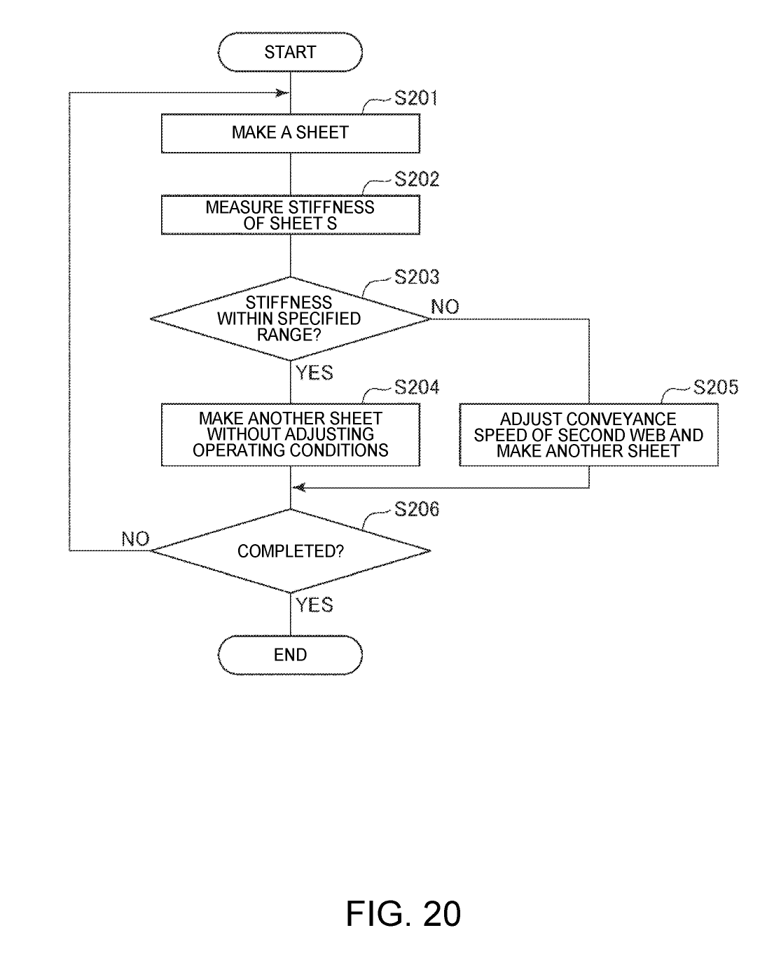

FIG. 20 is a flow chart of the control operation of the controller of a sheet manufacturing apparatus according to a fourth embodiment of the invention.

A fourth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the third embodiment except for the control operation of the controller.

Note that of step S201 to step S206, step S201 is the same as step S101 in the third embodiment, step S202 is the same as step S102 in the third embodiment, step S203 is the same as step S103 in the third embodiment, step S204 is the same as step S104 in the third embodiment, and step S206 is the same as step S106 in the third embodiment. As a result, only step S205 is described below.

If in step S203 the controller 3 determines the stiffness is not within the previously set stiffness range, in step S205 the controller 3 changes the settings of the operating conditions that were set in step S201, and makes another sheet S.

In this embodiment, in step S205, the controller 3 adjusts the thickness of the second web M8 by adjusting the speed of the mesh belt 191 (the speed of the tension rollers 192).

For example, if the stiffness of the sheet S is below the stiffness range previously set in step S201, the speed of the mesh belt 191 is reduced from the speed set in step S201. As a result, the thickness of the second web M8 is increased from the setting made in step S201, and by increasing the thickness of the second web M8, the stiffness of the sheet S can be increased.

However, if the stiffness of the sheet S is above the stiffness range previously set in step S201, the speed of the mesh belt 191 is increased from the speed set in step S201. As a result, the thickness of the second web M8 is decreased from the setting made in step S201, and by decreasing the thickness of the second web M8, the stiffness of the sheet S can be decreased.

The sheet manufacturing apparatus 100 in this embodiment thus has a defibrator 13 that defibrates the feedstock M1 (sheet material), a resin supply device 171 that supplies resin P1 (resin material) to the defibrated material M3, and a second web forming device 19 (air-laying device) that forms the defibrated material M3 and resin P1 (resin material), that is, the mixture M7, into a sheet, and the controller 3 adjusts the thickness of the second web M8 (deposited material) formed on the second web forming device 19 (air-laying device). As a result, the stiffness of the sheets S made after the sheet S of which the stiffness was measured can be kept within the previously set range, and sheets S with the desired stiffness can be made. More specifically, stiffness can be adjusted by the simple method of adjusting the thickness of the second web M8.

### Embodiment 5

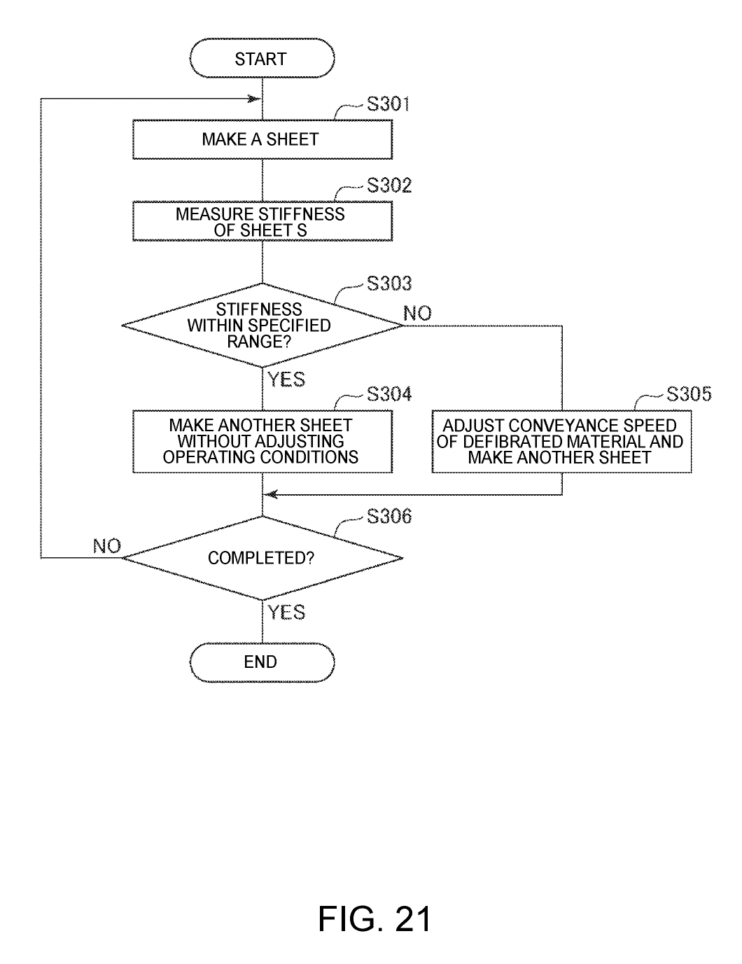

FIG. 21 is a flow chart of the control operation of the controller of a sheet manufacturing apparatus according to a fifth embodiment of the invention.

A fifth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the third embodiment except for the control operation of the controller.

Note that of step S301 to step S306, step S301 is the same as step S101 in the third embodiment, step S302 is the same as step S102 in the third embodiment, step S303 is the same as step S103 in the third embodiment, step S304 is the same as step S104 in the third embodiment, and step S306 is the same as step S106 in the third embodiment. As a result, only step S305 is described below.

If in step S303 the controller 3 determines the stiffness is not within the previously set stiffness range, in step S305 the controller 3 changes the settings of the operating conditions that were set in step S301, and makes another sheet S.

In this embodiment, in step S305, the controller 3 adjusts the thickness of the second web M8 by adjusting the conveyance speed of the defibrated material M3.

For example, if the stiffness of the sheet S is below the stiffness range previously set in step S301, the conveyance speed of the defibrated material M3 is increased from the speed set in step S301. As a result, the amount of defibrated material M3 (mixture M7) supplied per unit time to the mesh belt 191 can be increased, and the thickness of the second web M8 is increased from the setting made in step S301. By increasing the thickness of the second web M8, the stiffness of the sheet S can be increased.

For example, if the stiffness of the sheet S is above the stiffness range previously set in step S301, the conveyance speed of the defibrated material M3 is decreased from the speed set in step S301. As a result, the amount of defibrated material M3 (mixture M7) supplied per unit time to the mesh belt 191 can be decreased, and the thickness of the second web M8 is decreased from the setting made in step S301. By decreasing the thickness of the second web M8, the stiffness of the sheet S can be decreased.

Note that the conveyance speed of the defibrated material M3 can be adjusted by, for example, changing the conveyance speed (speed of travel) of the mesh belt 151, or adjusting the rate of flow through the conduit 172 by adjusting operation of the blower 173.

The sheet manufacturing apparatus 100 in this embodiment thus has a defibrator 13 that defibrates the feedstock M1 (sheet material), and the controller 3 adjusts the conveyance speed of the defibrated material M3. As a result, the stiffness of the sheets S made after the sheet S of which the stiffness was measured can be kept within the previously set range, and sheets S with the desired stiffness can be made. More specifically, stiffness can be adjusted by the simple method of adjusting the conveyance speed of the defibrated material M3.

### Embodiment 6

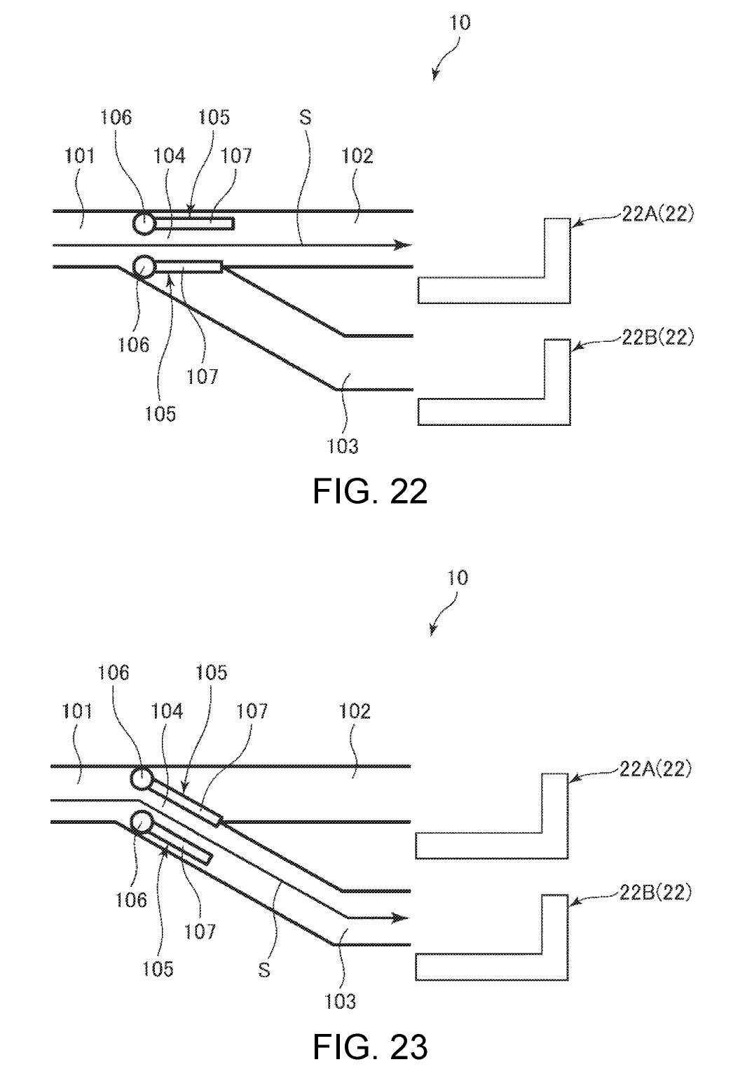

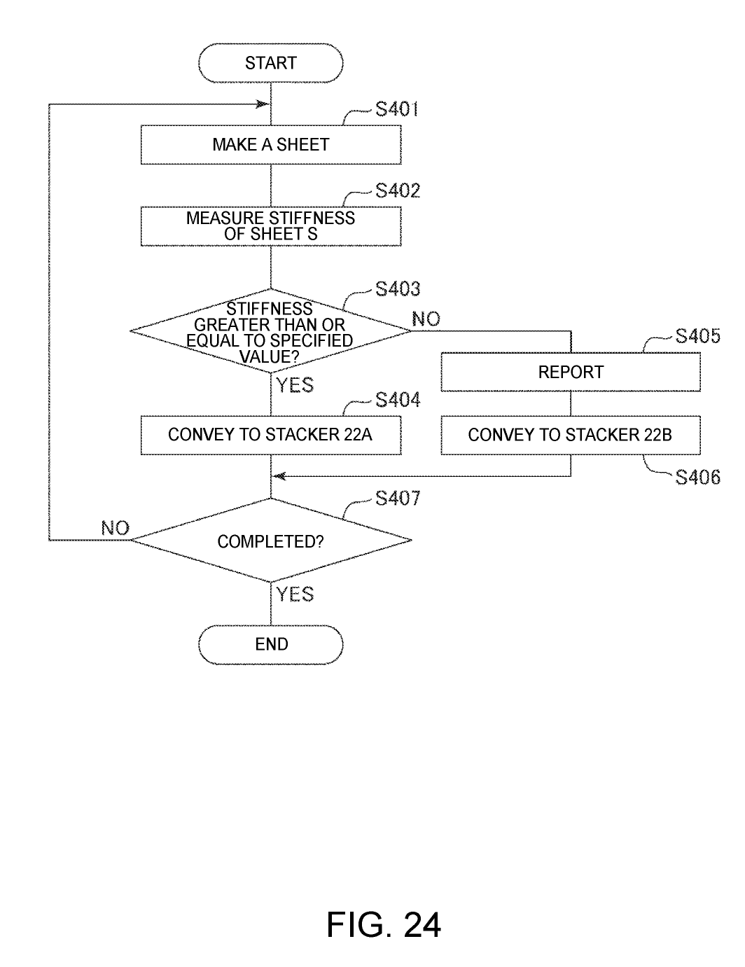

FIG. 22 is a flow chart of the control operation of the sorter in the stiffness tester of a sheet manufacturing apparatus according to a sixth embodiment of the invention. FIG. 23 is a flow chart of the control operation of the sorter in the stiffness tester of a sheet manufacturing apparatus according to a sixth embodiment of the invention. FIG. 24 is a flow chart of the control operation of the controller of a sheet manufacturing apparatus according to a sixth embodiment of the invention.

A sixth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the third embodiment except for the addition of a sorter 10 to the stiffness tester 1.

As shown in FIG. 22 and FIG. 23, a sorter 10 that sorts the sheets S according to the stiffness of the sheets S is provided in the stiffness tester 1. The sorter 10 is located on the right side of the stiffness tester 1 as seen in FIG. 15 to FIG. 18, that is, on the downstream side in the sheet S conveyance direction.

The sorter 10 has a main channel 101 through which the sheets S conveyed by the conveyance rollers 6 (second conveyance rollers 62) shown in FIG. 15 to FIG. 18 pass, and multiple (two in the example shown in the figures) branch channels 102 and 103 that continue from the main channel 101, and a path changer 105 disposed to the junction 104 between the main channel 101 and branch channels 102 and 103.

One branch channel 102 is disposed as an extension of the main channel 101. The other branch channel 103 extends on a line diverging from the main channel 101 at the junction 104 and then turning and extending in the same direction as the one branch channel 102. A stacker 22A (stacker 22) is disposed at the exit from branch channel 102, and another stacker 22B (stacker 22) is disposed at the exit from branch channel 103.

In this example, the path changer 105 has a pair of pivots 106 disposed to the inside wall of the channel, and a pair of flappers 107 connected to the pivots 106. The pivots 106 and flappers 107 are disposed to opposite sides of the junction 104. A motor is incorporated in each pivot 106, and the controller 8 controls operation of the motors.

The path changer 105 can be set to a first state with the flappers 107 aligned with the main channel 101 as shown in FIG. 22, or a second state with the flappers 107 diverted away from the main channel 101 as shown in FIG. 23. In the first state, the flappers 107 close the entrance to the branch channel 103, and the main channel 101 communicates with branch channel 102. In the second state, the flappers 107 close the entrance to the branch channel 102, and the main channel 101 communicates with branch channel 103.

As a result, in the first state, a sheet S traveling through the main channel 101 passes into branch channel 102 and is discharged to stacker 22A. In the second state, a sheet S traveling through the main channel 101 passes into branch channel 103 and is discharged to stacker 22B. As a result, sheets S are directed to stacker 22A or stacker 22B by the sorter 10.

The control operation of the controller 3 is described next with reference to the flow chart in FIG. 24.

Note that of step S401 to step S407, step S401 is the same as step S101 in the third embodiment, step S402 is the same as step S102 in the third embodiment, and step S407 is the same as step S106 in the third embodiment. As a result, only steps S403, S404, S405, S406 are described below.

In this embodiment, whether or not the stiffness of the measured sheet S is greater than or equal to a specific previously set value (reference value) is determined in step S403. If the measured sheet S stiffness is greater than the previously set reference value, the sheet S is determined to acceptable, and in step S404 is conveyed to stacker 22A.

However, if the measured sheet S stiffness is below the previously set reference value, the sheet S is determined to be a reject (not acceptable). As a result, that the sheet S is a reject is reported in step S405, and is conveyed to stacker 22B in step S406.

This embodiment of the invention thus determines if each sheet S that is made is acceptable or not, and sorts the sheets S accordingly to stacker 22A or stacker 22B. This prevents unacceptable sheets S from being mixed with acceptable sheets S.

As described above, a stiffness tester 1 according to this embodiment has a sorter 10 that sorts the sheets S (sheet material) based on the stiffness detected by the detector 7. As a result, the sheets S can be sorted based on the output of the detector 7.

### Embodiment 7

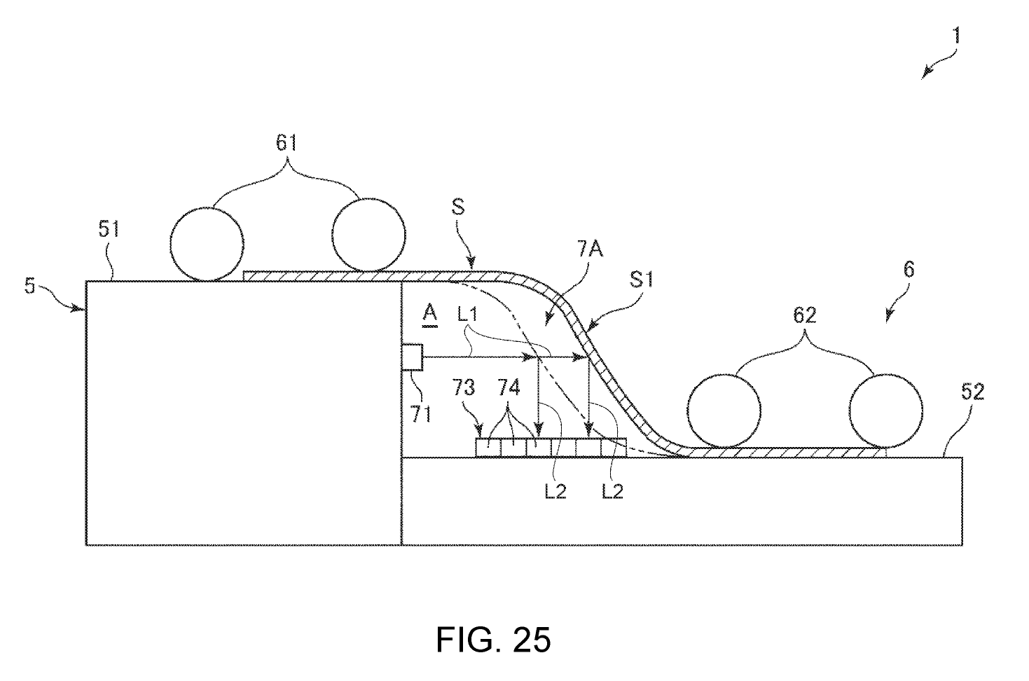

FIG. 25 illustrates a stiffness tester of a sheet manufacturing apparatus according to a seventh embodiment of the invention.

A seventh embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the third embodiment except for the configuration of the detector.

As shown in FIG. 25, the detector 7A of the stiffness tester 1 according to this embodiment has an emitter 71 and a photodetector array 73. The emitter 71 is disposed to a vertical surface of the stepped part of the platform 5, and emits a light beam L1 to the right as seen in FIG. 25. The photodetector array 73 is disposed on top of the second surface 52, and receives the reflection L2 of the light beam L1 from the bottom side of the sheet S.

The photodetector array 73 comprises multiple (six in the configuration shown in the figure) photodetectors 74 disposed along the optical axis of the light beam L1. Each of the photodetectors 74 is electrically connected to the controller 8 (not shown in the figure), and when light is detected, converts the detected light to an electric signal and outputs to the controller 8.

For example, if the stiffness of the sheet S is relatively high, the sag in the sheet S caused by the weight of the sheet S is relatively small as indicated by the solid lines in FIG. 25. In this case, the distance to the deformed portion S1 is relatively long, and the photodetector 74 that detects the reflection L2 is a photodetector 74 further to the right.

However, if the stiffness of the sheet S is relatively low, the sag in the sheet S caused by the weight of the sheet S is relatively great as indicated by the dot-dot-dash line in FIG. 25. In this case, the distance to the deformed portion S1 is relatively short, and the photodetector 74 that detects the reflection L2 is a photodetector 74 further to the left, that is, a photodetector 74 further to the left than when the stiffness of the sheet S is relatively high.

A detection curve or table relating the location of the photodetector 74 that detected the reflection L2 to the stiffness of the sheet S is also stored in the storage 82 (not shown in the figure). Based on the detection curve or table, the CPU 81 can determine the stiffness of the sheet S.

This embodiment can determined the stiffness of a sheet S based on the location of the photodetector 74 that detected the reflection L2. This embodiment also has the same effect as the third embodiment described above. The overall size of the stiffness tester 1 can also be reduced by disposing the detector 7A on the platform 5.

### Embodiment 8

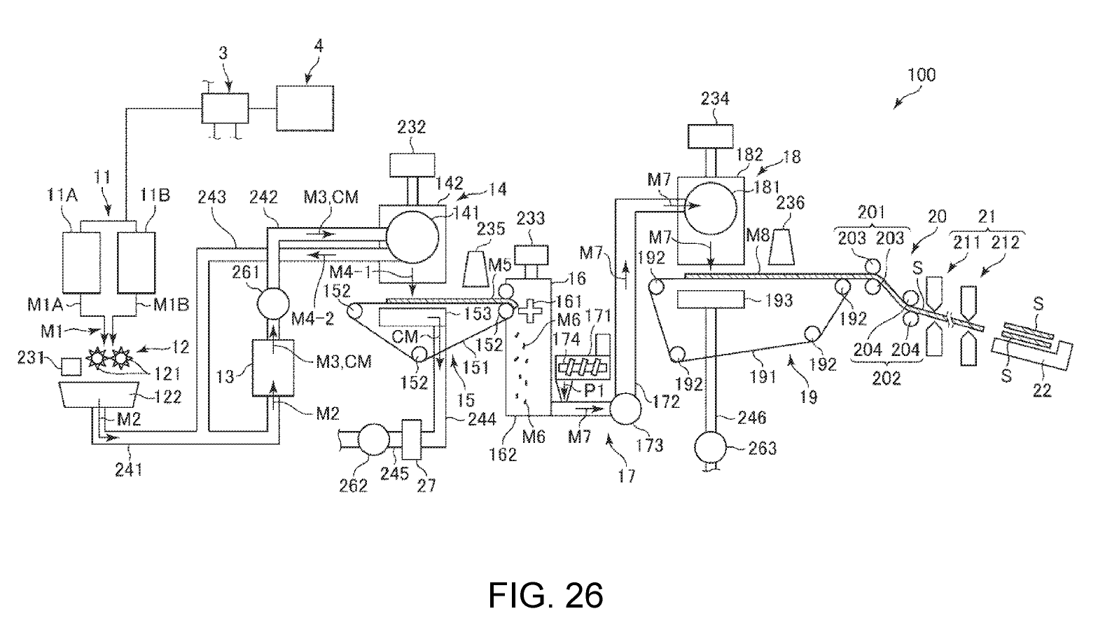

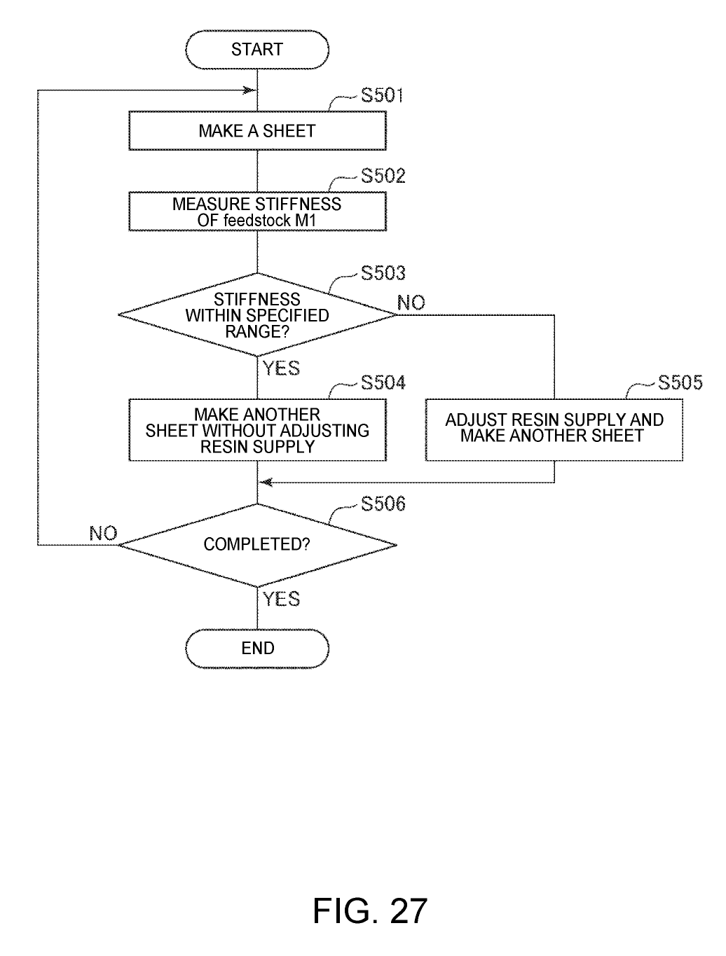

FIG. 26 schematically illustrates the configuration of sheet manufacturing apparatus according to an eighth embodiment of the invention. FIG. 27 is a flow chart of the control operation of the controller shown in FIG. 26.

An eighth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the third embodiment except for the location of the stiffness tester.

As shown in FIG. 26, the stiffness tester 1 in the sheet manufacturing apparatus 100 according to this embodiment is disposed between the feedstock supply device 11 and shredder 12, and measures the stiffness of the feedstock M1 (feedstock sheets) supplied as the feedstock. As described below, this enables adjusting the operating conditions of the sheet manufacturing apparatus 100 according to the stiffness of the feedstock M1.

Note that the stiffness tester 1 may be incorporated in the feedstock supply device 11. More specifically, the stiffness tester 1 may be integrated into the feedstock supply device 11.

The control operation of the controller 3 is described next with reference to the flow chart in FIG. 27.

First, in step S501, sheet S production starts using the operating conditions set according to the stiffness set by the operator. In other words, supplying feedstock M1 starts.

Next, the stiffness of the feedstock M1 is measured in step S502. This embodiment measures the stiffness of the feedstock M1 supplied from the feedstock supply device 11 to the shredder 12.

Next, in step S503, the controller 3 determines whether or not the stiffness determined in step S502 is within a previously set stiffness range. If the stiffness determined is within the previously set stiffness range, sheet S production continues in step S504 without changing the settings of the operating conditions that were set in step S501.

However, if in step S503 the controller 3 determines the stiffness is not within the previously set stiffness range, in step S505 the controller 3 changes the settings of the operating conditions that were set in step S501, and continues sheet S production.

In this example, the amount of resin P1 supplied by the resin supply device 171 is adjusted. For example, if the stiffness of the sheet S is below the stiffness range previously set in step S501, the supply of resin P1 is increased from the level set in step S501. If the stiffness of the sheet S is above the stiffness range previously set in step S501, the supply of resin P1 is decreased from the level set in step S501. As a result, the stiffness of the sheets S can be kept within the previously set range, and sheets S with the desired stiffness can be made.

Next, in step S506, the controller 3 determines if sheet S production was completed, that is, if the number of sheets S that were made has reached the set count, and if the specified count has not been reached, returns to step S501 and continues making sheets S. When the specified count has been reached, the process ends.

Note that this embodiment describes adjusting the supply of resin P1 as the setting of the operating conditions of the sheet manufacturing apparatus 100 to adjust, but the invention is not so limited. For example, this embodiment may also be configured to adjust the conveyance speed of the defibrated material M3 or the thickness of the second web M8 as described above.

### Embodiment 9

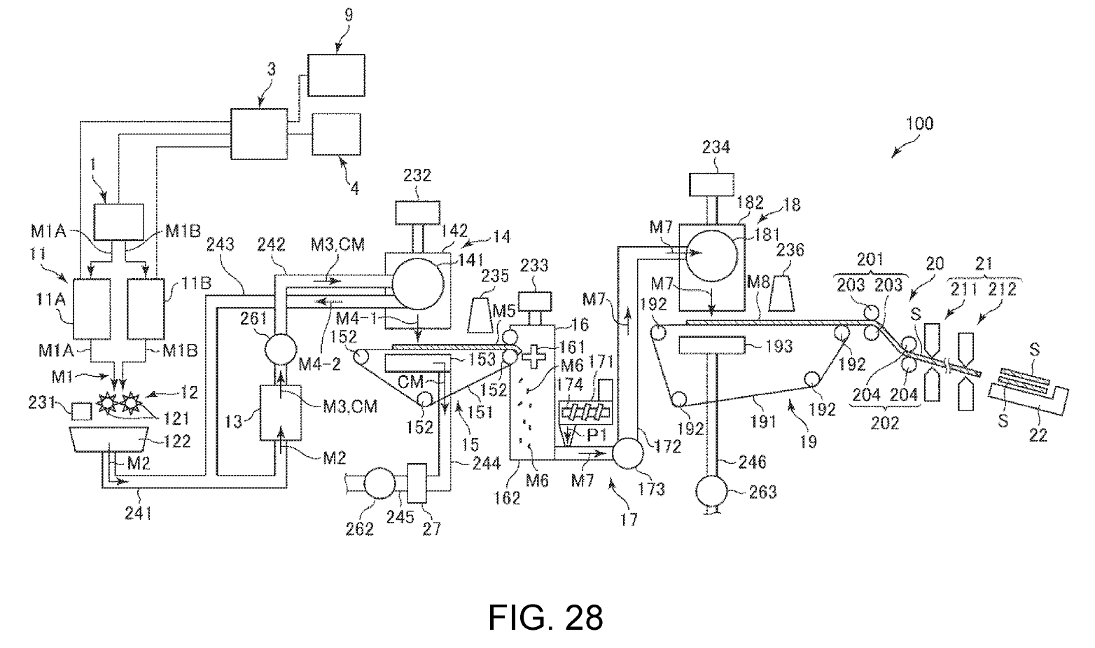

FIG. 28 schematically illustrates the configuration of a sheet manufacturing apparatus according to the ninth embodiment of the invention.

A ninth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the seventh embodiment described above except for the location of the stiffness tester and the configuration of the feedstock supply device.

As shown in FIG. 28, the stiffness of the feedstock M1 is measured by the stiffness tester 1 in the sheet manufacturing apparatus 100 according to this embodiment, and based on the result, the paper (sheet) of the feedstock M1 is directed by the sorter 10 to the first feedstock supply device 11A (first material supply device) or the second feedstock supply device 11B (second material supply device).

As shown in FIG. 28, the feedstock supply device 11 has a first feedstock supply device 11A (first material supply device) and a second feedstock supply device 11B (second material supply device). Paper (sheets) of a feedstock M1 with stiffness greater than a specific value (threshold) (referred to below as feedstock M1A) is sorted to the first feedstock supply device 11A, and paper (sheets) of a feedstock M1 with stiffness below a specific value (threshold) (referred to below as feedstock M1B) is sorted to the second feedstock supply device 11B.

The first feedstock supply device 11A and second feedstock supply device 11B are electrically connected to the controller 3, and operation thereof is controlled by the controller 3. The first feedstock supply device 11A and second feedstock supply device 11B each have a hopper in which the feedstock paper is stocked, and a power source such as a motor, and when the power source is driven, feed the first feedstock M1A or second feedstock M1B one sheet at a time. The controller 3 controls (supplies power) to the first feedstock supply device 11A and second feedstock supply device 11B according to the stiffness setting made by the operator, and can adjust the supply ratio (supply volumes) of the first feedstock M1A and second feedstock M1B. As a result, the stiffness of the manufactured sheets S can be easily adjusted.

As described above, the sheet manufacturing apparatus 100 according to this embodiment has multiple feedstock sheet supply devices (first feedstock supply device 11A and second feedstock supply device 11B) that supply feedstock M1 (feedstock sheets) of different stiffness, and based on the stiffness detected by the detector 7 of the stiffness tester 1, sends the feedstock M1 (feedstock sheets) to the appropriate feedstock sheet supply device (first feedstock supply device 11A or second feedstock supply device 11B). As a result, the supply ratio (supply volumes) of the first feedstock M1A and second feedstock M1B can be adjusted to easily adjust the stiffness of the manufactured sheets S.

Note that the second feedstock M1B directed to the second feedstock supply device 11B may also be discarded without being used to make sheets.

### Embodiment 10

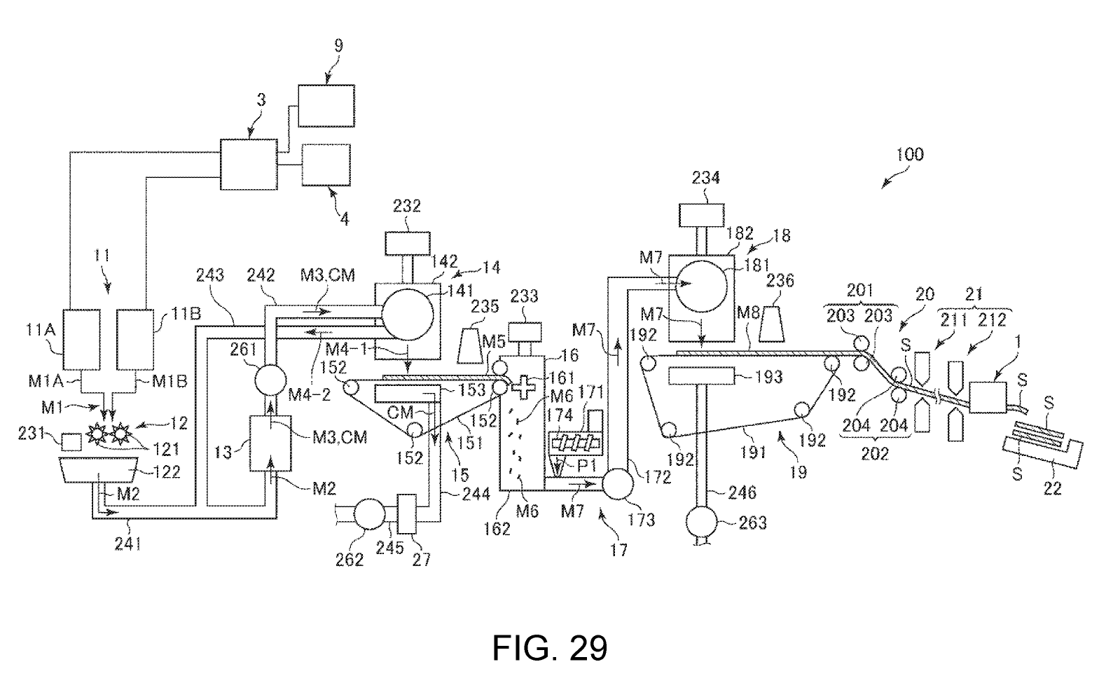

FIG. 29 schematically illustrates the configuration of a sheet manufacturing apparatus according to the tenth embodiment of the invention.

A tenth embodiment of a sheet manufacturing apparatus according to the invention is described below with reference to the accompanying figures, focusing on the differences between this and the foregoing embodiment, and omitting or simplifying further description of like elements.

The sheet manufacturing apparatus according to this embodiment is the same as the ninth embodiment described above except for the location of the stiffness tester and the configuration of the feedstock supply device.

In a sheet manufacturing apparatus 100 according to this embodiment, the stiffness tester 1 is disposed between the paper cutter 21 and stacker 22. In addition, the feedstock supply device 11 comprises a first feedstock supply device 11A and second feedstock supply device 11B as in the ninth embodiment.

More specifically, this embodiment of the invention has multiple feedstock sheet supply devices (first feedstock supply device 11A and second feedstock supply device 11B) that supply feedstock M1 (feedstock sheets) of different stiffness as the feedstock. This embodiment also selects the feedstock M1 (feedstock sheets) supplied in the sheet manufacturing process according to the detection result (the detected sheet S stiffness) of the detector 7. As a result, the supply ratio (supply volumes) of the first feedstock M1A and second feedstock M1B can be adjusted to adjust the stiffness of the sheets S that are produced.

For example, if the stiffness of the sheet S is below a previously set stiffness range, the amount of first feedstock M1A having relatively high stiffness can be increased. If the stiffness of the sheet S is above a previously set stiffness range, the amount of second feedstock M1B having relatively low stiffness can be increased. As a result, the stiffness of the manufactured sheets S can be easily adjusted.

Preferred embodiments of a sheet manufacturing apparatus according to the invention are described above, but the invention is not so limited. Parts of the sheet manufacturing apparatus may also replaced with equivalent configurations having the same function. Other configurations may also be added as desired.

In addition, a sheet manufacturing apparatus according to the invention may be a combination of any two or more desirable configurations (features) of the embodiments described above.

In the embodiments described above, the first material and second material are described as sheets (paper), but the invention is not so limited. For example, the first material and second material may be defibrated material that has already been defibrated. In this case, the shredder and defibrator can be omitted. The first material and second material may also be the shreds of a shredded material. In this case, the shredder can be omitted.

In the third mode in the foregoing embodiments, the number of sheets in each first state is the same, but the invention is not so limited and the number of sheets may differ. The number of sheets in each second state is the same, but the invention is not so limited and the number of sheets may differ.

The foregoing embodiments describe configurations that adjust the supply volume (supply ratio) of the first material and second material by controlling the number of sheets, but the invention is not so limited and may be configure to adjust the supply based on weight. In this case, the stiffness can be accurately adjusted even if the first material and second material are sheet materials and the size or thickness of the sheets vary, and the stiffness can be accurately adjusted even if the first material and second material are supplied as defibrated material or shreds.

The foregoing embodiments also describe configurations in which the operator selects the rank indicating the stiffness of the sheets that are made, but the invention is not so limited. For example, configurations enabling the operator to select the first mode, second mode, or third mode are also conceivable. Configurations enabling the operator to select the supply ratio (supply volume) of the first material and second material in the third mode are also conceivable.

If multiple types of fiber of different properties are contained in the first material and second material, configurations that use fibers of the same properties as the first fiber and second fiber, and compare the average length of the first fiber and the average length of the second fiber are also conceivable.

Note that in the foregoing embodiments, a configuration that adds a paper strengthener when the detected stiffness is low is also possible. In this case, configurations that supply the paper strengthener with the resin by the resin supply device, or supply only the paper strengthener, are also conceivable.

The thickness of the sheets (sheet material) that are made by the sheet manufacturing apparatus in the foregoing embodiments is constant, but the invention is not so limited. For example, the thickness may be adjusted according to the stiffness of the sheets (sheet material).

The detector in the foregoing embodiments is an optical device, but the invention is not so limited. For example, configurations that contact the sheet material (feedstock sheets) and measure stiffness by the contact pressure are also possible.

Furthermore, the detect in the foregoing embodiments is configured to detect deformation from the sheet material (feedstock sheets) sagging due to their own weight, but the invention is not so limited. For example, configurations that detect deformation caused by apply bending stress causing the sheet material (feedstock sheet) to sag are also possible.

Furthermore, the detector in the foregoing embodiments is a reflective configuration that detects reflected light, but the invention is not so limited. For example, a transmissive device that emits light to the sheet material and detects light passing through the sheet material are also possible.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application Nos: 2017-189890, filed Sep. 29, 2017 and 2017-189891, filed Sep. 29, 2017 are expressly incorporated by reference herein.

What is claimed is:

1. A sheet manufacturing apparatus comprising:
a first material supply device that supplies a first material containing fiber;
a second material supply device that supplies a second material containing fiber with an average fiber length shorter than the average fiber length of the first material; and
a controller configured to control operation of the first material supply device and second material supply device.

2. The sheet manufacturing apparatus described in claim 1, wherein:
the controller has a first mode in which the first material is supplied from the first material supply device, and a second mode in which the second material is supplied from the second material supply device, and selects either the first mode or the second mode.

3. The sheet manufacturing apparatus described in claim 1, wherein:
the controller has a third mode including a first state in which the first material is supplied from the first material supply device, and a second state in which the second material is supplied from the second material supply device, and supplies material from both the first material supply device and the second material supply device.

4. The sheet manufacturing apparatus described in claim 2, wherein:
the controller determines the operating mode according to the stiffness of the manufactured sheets.

5. The sheet manufacturing apparatus described in claim 3, wherein:
in the third mode, the controller repeatedly alternates between the first state and second state.

6. The sheet manufacturing apparatus described in claim 3, wherein:
in the third mode, the controller can adjust a first supply volume of the first material in the first state, and a second supply volume of the second material in the second state.

7. The sheet manufacturing apparatus described in claim 6, wherein:
the controller determines the first supply volume and the second supply volume according to the stiffness of the manufactured sheets.

8. The sheet manufacturing apparatus described in claim 3, wherein:
in the third mode, the controller can adjust the timing when the first material is supplied in the first state, and the timing when the second material is supplied in the second state, based on the average fiber length of the first material and the average fiber length of the second material.

9. The sheet manufacturing apparatus described in claim 8, wherein:
the first material and second material are sheet materials; and
the controller adjusts the first supply volume and second supply volume by adjusting the number of sheets supplied.

10. The sheet manufacturing apparatus described in claim 9, further comprising:
a defibrator configured to defibrate the sheet material.

11. The sheet manufacturing apparatus described in claim 1, further comprising:
a space that allows deformation of the sheet material;
a detector configured to detect deformation of the sheet material in the space; and
an evaluator configured to determine the stiffness of the sheet material based on the detection result of the detector.

12. The sheet manufacturing apparatus described in claim 11, wherein:
the detector is an optical device configured to measure a length of deformation of the sheet material.

13. The sheet manufacturing apparatus described in claim 1, wherein:
the detector detects deformation resulting from the sheet material sagging due to the weight of the sheet material.

14. The sheet manufacturing apparatus described in claim 11, further comprising:
a reporting device configured to report the detection result of the detector.

15. The sheet manufacturing apparatus described in claim 11, further comprising:
a sorter configured to sort the sheet material according to the detection result of the detector.

16. The sheet manufacturing apparatus described in claim 11, further comprising:
a controller configured to adjust an operating condition of the sheet manufacturing apparatus based on the detection result of the detector.
